(19) United States
(12) Patent Application Publication
(10) Pub. No.: US 2026/0145074 A1
(43) Pub. Date: May 28, 2026

(54) GAME SKILL CASTING METHOD AND APPARATUS, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventor: Xun HU, Shenzhen (CN)

(21) Appl. No.: 19/447,825

(22) Filed: Jan. 13, 2026

Related U.S. Application Data
(63) Continuation of application No. PCT/CN2024/121035, filed on Sep. 25, 2024.

(30) Foreign Application Priority Data
Dec. 19, 2023 (CN) 202311763265.2

(51) Int. Cl. A63F 13/58

(52) U.S. Cl. CPC A63F 13/58

(57) ABSTRACT

This application discloses a game skill casting method performed by a computer device. The method includes: displaying a player character located in a virtual environment; controlling the player character to cast an initiation skill in response to a first skill casting operation by a user; controlling the player character to cast a flash skill in response to receiving a second skill casting operation by the user in a process of casting the initiation skill; in response to a virtual character existing in the virtual environment in a process of casting the flash skill, determining one of a skill impact location of the initiation skill and a skill impact location of the flash skill as a location of the virtual character; and applying a correspond one of the initiation skill and the flash skill on the virtual character at the location of the virtual character.

### CROSS-REFERENCE TO RELATED APPLICATIONS

This application is a continuation application of PCT Patent Application No. PCT/CN2024/121035, entitled “GAME SKILL CASTING METHOD AND APPARATUS, ELECTRONIC DEVICE, COMPUTER-READABLE STORAGE MEDIUM, AND COMPUTER PROGRAM PRODUCT” filed on September 25, 2024, which claims priority to Chinese Patent Application No. 202311763265.2, entitled “GAME SKILL CASTING METHOD AND APPARATUS, ELECTRONIC DEVICE, COMPUTER-READABLE STORAGE MEDIUM, AND COMPUTER PROGRAM PRODUCT” filed on December 19, 2023, all of which are incorporated herein by reference in their entirety.

### FIELD OF THE TECHNOLOGY

This application relates to the field of man-machine interaction, and in particular, to a game skill casting method and apparatus, an electronic device, a computer-readable storage medium, and a computer program product.

### BACKGROUND OF THE DISCLOSURE

In a multiplayer online battle arena (MOBA) game, a virtual character is typically configured with a plurality of skills. A user can control the virtual character to cast a skill in a battle, and these skills are typically set on a game interface as independent controls.

In a related technology, a user controls a virtual character to cast a skill, to lower an attribute value (for example, a health point) of another virtual character. The user can control the virtual character to cast a directional skill, for example, a flash skill, in a virtual environment, to kill a virtual object controlled by another game user. For example, the user may combine the flash skill and another skill into a combo, to kill another virtual character.

However, when the user uses a combination of the flash skill and the another skill to kill the another virtual character, the user needs to trigger the flash skill at a proper moment and further needs to adjust a casting direction of the flash skill, leading to high operation difficulty and a low hit rate.

### SUMMARY

This application provides a game skill casting method and apparatus, an electronic device, a computer-readable storage medium, and a computer program product. The technical solutions are as follows.

According to an aspect of this application, a game skill casting method is performed by a computer device. The method includes:

displaying a player character located in a virtual environment;

controlling the player character to cast an initiation skill in response to a first skill casting operation by a user of the computer device;

controlling the player character to cast a flash skill in response to receiving a second skill casting operation by the user of the computer device in a process of casting the initiation skill;

in response to a virtual character existing in the virtual environment in a process of casting the flash skill, determining one of a skill impact location of the initiation skill and a skill impact location of the flash skill as a location of the virtual character; and

applying a correspond one of the initiation skill and the flash skill on the virtual character at the location of the virtual character.

According to another aspect of this application, a computer device is provided, including a processor and a memory, the memory storing a computer program, the computer program, when executed by the processor, causing the computer device to implement the foregoing game skill casting method.

According to another aspect of this application, a non-transitory computer-readable storage medium is provided, having executable instructions stored therein, the executable instructions, when executed by a processor of a computer device, causing the computer device to implement the foregoing game skill casting method.

The technical solutions provided in the embodiments of this application achieve at least the following beneficial effects:

The embodiments of this application provide a game skill casting method. In response to a casting operation on an initiation skill, a player character is controlled to cast the initiation skill in a virtual environment; in response to receiving a casting operation on a flash skill in a casting process of the initiation skill, the player character is controlled to cast the flash skill in the virtual environment, and a user does not need to adjust a casting direction and a casting distance of the flash skill in a process of casting the flash skill; and in response to a virtual character existing in the virtual environment in the casting process of the flash skill, at least one of a skill impact location of the initiation skill and a skill impact location of the flash skill is displayed as a location of the virtual character. This manner simplifies operations of the user and also improves a hit rate of the initiation skill.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show only some embodiments of this application, and a person of ordinary skill in the art may still derive other accompanying drawings from these accompanying drawings without creative efforts.

FIG. 1 is a schematic architectural diagram of a computer system according to an exemplary embodiment of this application.

FIG. 2 is a first schematic diagram of a principle of a game skill casting method according to an exemplary embodiment of this application.

FIG. 3 is a first flowchart of a game skill casting method according to an exemplary embodiment of this application.

FIG. 4 is a second flowchart of a game skill casting method according to an exemplary embodiment of this application.

FIG. 5 is a second schematic diagram of a principle of a game skill casting method according to an exemplary embodiment of this application.

FIG. 6 is a third flowchart of a game skill casting method according to an exemplary embodiment of this application.

FIG. 7 is a third schematic diagram of a principle of a game skill casting method according to an exemplary embodiment of this application.

FIG. 8 is a fourth schematic diagram of a principle of a game skill casting method according to an exemplary embodiment of this application.

FIG. 9 is a fifth schematic diagram of a principle of a game skill casting method according to an exemplary embodiment of this application.

FIG. 10 is a fourth flowchart of a game skill casting method according to an exemplary embodiment of this application.

FIG. 11 is a sixth schematic diagram of a principle of a game skill casting method according to an exemplary embodiment of this application.

FIG. 12 is a fifth flowchart of a game skill casting method according to an exemplary embodiment of this application.

FIG. 13 is a sixth flowchart of a game skill casting method according to an exemplary embodiment of this application.

FIG. 14 is a seventh schematic diagram of a principle of a game skill casting method according to an exemplary embodiment of this application.

FIG. 15 is an eighth schematic diagram of a principle of a game skill casting method according to an exemplary embodiment of this application.

FIG. 16 is a ninth schematic diagram of a principle of a game skill casting method according to an exemplary embodiment of this application.

FIG. 17 is a seventh flowchart of a game skill casting method according to an exemplary embodiment of this application.

FIG. 18 is an eighth flowchart of a game skill casting method according to an exemplary embodiment of this application.

FIG. 19 is a ninth flowchart of a game skill casting method according to an exemplary embodiment of this application.

FIG. 20 is a structural block diagram of a game skill casting apparatus according to an exemplary embodiment of this application.

FIG. 21 is a schematic structural diagram of an apparatus of a computer device according to an exemplary embodiment of this application.

### DESCRIPTION OF EMBODIMENTS

To make the objectives, technical solutions, and advantages of this application clearer, implementations of this application are further described below in detail with reference to the accompanying drawings.

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations that are consistent with this application. On the contrary, the implementations are merely examples of devices and methods that are described in detail in the appended claims and that are consistent with some aspects of this application.

The terms used in this application are for the purpose of describing specific embodiments only and are not intended to limit this application. "A" and "the" in a singular form that are used in this application and the appended claims are intended to include a plural form unless another meaning is clearly indicated in context. The term "and/or" used herein indicates and includes any or all possible combinations of one or more associated listed items.

In this application, before related data of a user is collected and in a process of collecting the related data of the user, information about a prompt interface and a pop-up window may be displayed. The prompt interface and the pop-up window are configured for prompting the user that the related data of the user is being collected, so that in this application, only after a confirmation operation perform by the user on the prompt interface or the pop-up window is obtained, a related operation of obtaining the related data of the user is started, and otherwise (that is, when the confirmation operation performed by the user on the prompt interface or the pop-up window is not obtained), the related operation of obtaining the related data of the user ends, that is, the related data of the user is not obtained. In other words, in this application, all the collected data of the user is collected with consent and authorization of the user, and the collection, use, and processing of the related data of the user need to comply with the relevant laws, regulations, and standards of relevant countries and regions.

First, nouns involved in this application are introduced as follows.

(1) Virtual environment: The virtual environment is displayed (or provided) by an application program when run on a terminal. The virtual environment may be a simulated world of a real world, may be a semi-simulated and semi-fictional three-dimensional world, or may be a completely fictional three-dimensional world. The virtual environment may be any one of a two-dimensional virtual environment, a 2.5-dimensional virtual environment, and a three-dimensional virtual environment. For example, the virtual environment is further configured for a virtual environment battle between at least two virtual characters, and there are virtual resources available to the at least two virtual characters in the virtual environment.

(2) Virtual character: The virtual character is a movable object that is controlled by artificial intelligence (AI) and that is in the virtual environment. The movable object may be at least one of a virtual character, a virtual animal, and a cartoon person. For example, when the virtual environment is the three-dimensional virtual environment, the virtual character may be a three-dimensional virtual model. Each virtual character has a shape and a volume in the three-dimensional virtual environment, and occupies a partial space in the three-dimensional virtual environment. For example, the virtual character is a three-dimensional character constructed based on three-dimensional human skeleton technology. The virtual character wears different skins to implement different appearances. In some embodiments, the virtual character may alternatively be implemented by using a 2.5-dimensional model or a two-dimensional model. This is not limited in this embodiment of this application. The virtual character may be a player character controlled through an operation on a client, may be artificial intelligence (AI) set in a virtual scene battle through training, or may be a non-player character (NPC) set in virtual scene interaction.

(3) Player character (PC): The player character is a character controlled by a player in a game. The player plays a game by operating the PC, to determine a movement, a decision, and a development direction of the character. The PC typically has unique personality, a background story, and a capability. The player may improve a capability of the PC and learn a story background of a game in manners such as interacting with an NPC, completing a task, and exploring the world in the game.

(4) Initiation skill: The initiation skill is a skill that is first casted by a user when using a combo, and is typically configured for opening a battle or initiating an attack. For example, the initiation skill may be at least one of a damage skill, a control skill, a directional skill, a directional movement skill, or a skill with another special effect. The user needs to select and cast the initiation skill to start a combo.

(5) Flash skill: The flash skill is a short-distance instant teleportation skill, allowing a virtual character controlled by a user to instantaneously move to a specified location, or instantaneously move by a preset distance length (for example, 500 yards in a game world).

(6) Combo: The combo means that a user rapidly and continuously casts a plurality of skills in a game to form a combined skill, to achieve a maximum damage output or control effect.

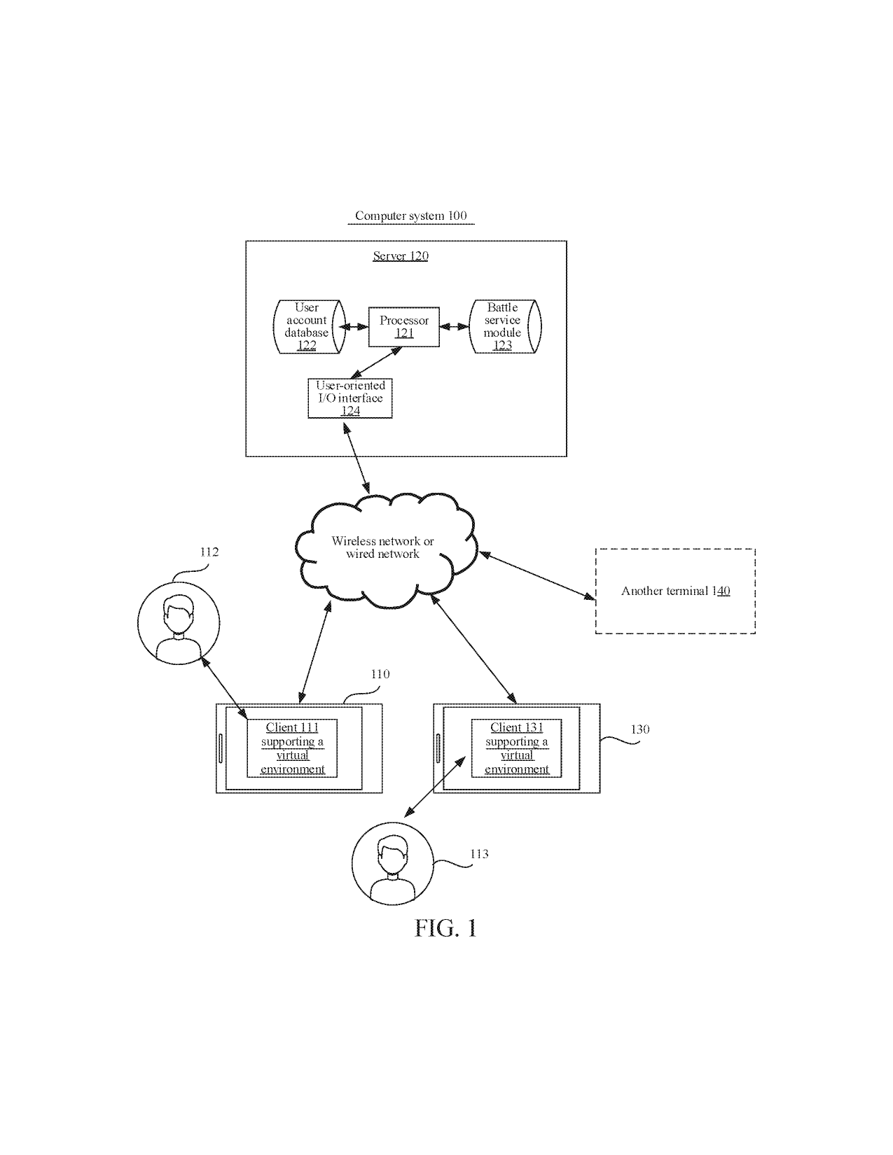

FIG. 1 is a schematic diagram of a computer system according to an exemplary embodiment of this application. The computer system 100 may include: a first terminal 110, a server 120, and a second terminal 130.

A client 111 supporting a virtual environment is installed and run on the first terminal 110, and the client 111 may be a multiplayer online battle program. When the first terminal 110 runs the client 111, a user interface of the client 111 is displayed on a screen of the first terminal 110. The client 111 may be any one of a multiplayer online game, an escape shooting game, a virtual reality (VR) application program, an augmented reality (AR) program, a three-dimensional map program, a virtual reality game, an augmented reality game, a first-person shooting (FPS) game, a third-person shooting (TPS) game, a MOBA game, and a simulation game (SLG). In this embodiment, an example in which the client 111 is the MOBA game is used for description. The first terminal 110 is a terminal used by a first user 112. The first user 112 controls, by using the first terminal 110, a player character in a virtual environment to perform activities or operate a virtual item owned by the player character. The player character may be referred to as a virtual character of the first user 112. The first user 112 may perform an operation such as assembling, disassembling, or uninstalling on the virtual item owned by the player character. This is not limited in this application. For example, the player character is a game virtual character, for example, a simulated person character or a cartoon person character.

A client 131 supporting a virtual environment is installed and run on the second terminal 130, and the client 131 may be a multiplayer online battle program. When the second terminal 130 runs the client 131, a user interface of the client 131 is displayed on a screen of the second terminal 130. The client may be any one of a MOBA game, an escape shooting game, a VR application program, an AR program, a three-dimensional map program, a virtual reality game, an augmented reality game, an FPS, a TPS, and an SLG. In this embodiment, an example in which the client is the MOBA game is used for description. The second terminal 130 is a terminal used by a second user 113. The second user 113 controls, by using the second terminal 130, a virtual character in the virtual environment to perform activities and operate a virtual item owned by the virtual character. The virtual character may be referred to as a virtual character of the second user 113. For example, the virtual character is a game virtual character, for example, a simulated person character or a cartoon person character.

In some embodiments, the player character and the virtual character are in the same virtual environment. The player character and the virtual character may belong to the same camp, the same team, or the same organization, have a friend relationship, or have a temporary communication permission. For example, the player character and the virtual character may belong to different camps, different teams, or different organizations, or have a hostile relationship with each other.

In some embodiments, the client installed on the first terminal 110 is the same as the client installed on the second terminal 130, or the clients installed on the two terminals are the same type of clients of different operating system platforms (an Android system or an iOS system). The first terminal 110 may generally refer to one of a plurality of terminals, and the second terminal 130 may generally refer to another one of a plurality of terminals. In this embodiment, only the first terminal 110 and the second terminal 130 are used as an example for description. The first terminal 110 and the second terminal 130 are of the same or different device types, the device type including at least one of a smartphone, a tablet computer, an e-book reader, an MP3 player, an MP4 player, a laptop, and a desktop computer.

FIG. 1 shows only two terminals. However, a plurality of other terminals 140 may access the server 120 in different embodiments. One or more terminals 140 are terminals corresponding to a developer. A developing and editing platform for a client supporting the virtual environment is installed on the terminal 140. The developer may edit and update the client on the terminal 130 and transmit an updated client installation package to the server 120 by using a wired or wireless network. The first terminal 110 may download the client installation package from the server 120 to update the client.

The server 120 includes at least one of one server, a plurality of servers, a cloud computing platform, and a virtualization center. The server 120 is configured to provide a background service to the client 111. The server 120 is responsible for primary computing work, and the first terminal 110 is responsible for secondary computing work. Alternatively, the server 120 is responsible for secondary computing work, and the first terminal 110 is responsible for primary computing work. Alternatively, the server 120 and the first terminal 110 perform collaborative computing by using a distributed computing architecture.

The server 120 includes a processor 121, a user account database 122, a battle service module 123, and a user-oriented input/output interface (I/O interface) 124. The processor 121 is configured to load instructions stored in the server 120, and process data in the user account database 122 and the battle service module 123. The user account database 122 is configured to store data of user accounts used by the first terminal 110 and the another terminal 140, for example, avatars of the user accounts, nicknames of the user accounts, battle effectiveness indexes of the user accounts, and service zones of the user accounts. The battle service module 123 is configured to provide a plurality of battle rooms for the users to battle, for example, a 1V1 battle room, a 3V3 battle room, a 5V5 battle room, and the like. The user-oriented I/O interface 124 is configured to establish communication between the first terminal 110 and/or the another terminal 140 by using a wireless network or a wired network for data exchange.

The first terminal 110, the second terminal 130, and the another terminal 140 are connected to the server 120 through a wireless network or a wired network.

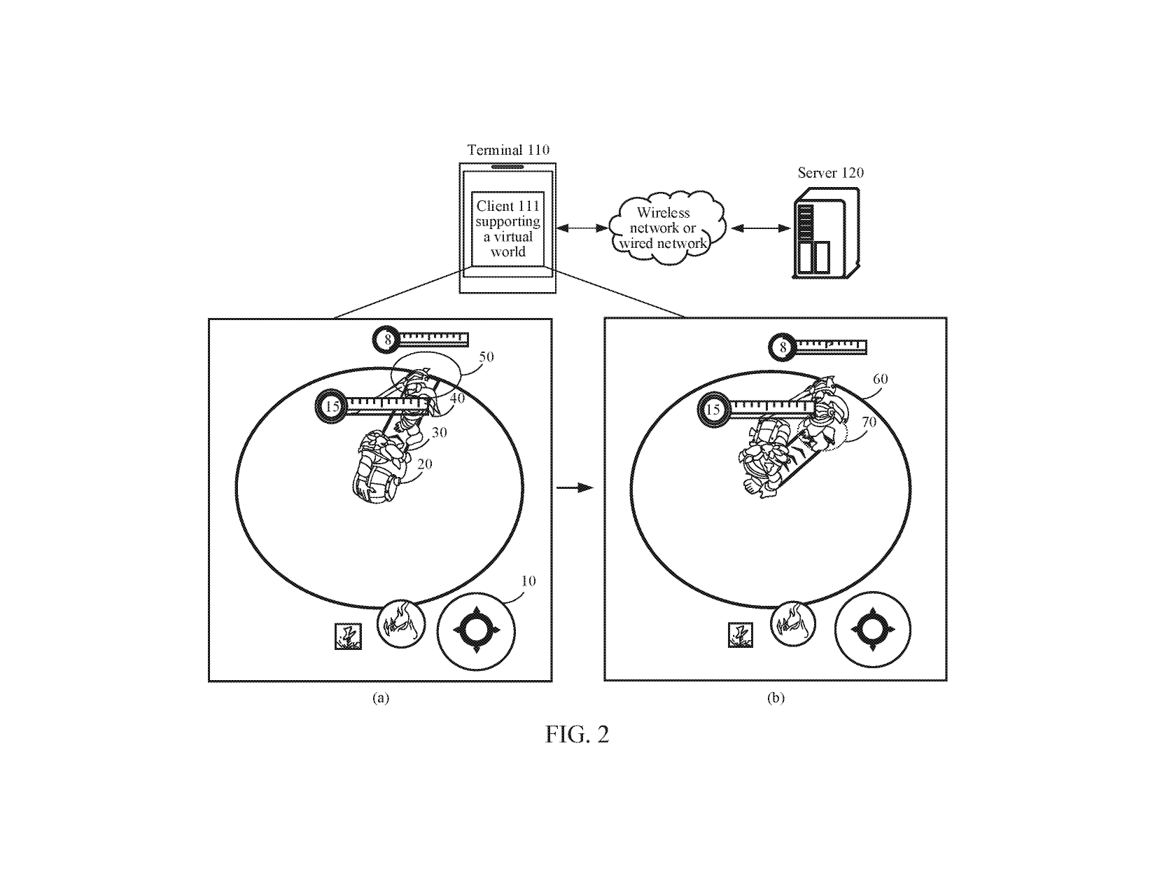

For example, FIG. 2 is a first schematic diagram of a principle of a game skill casting method according to an exemplary embodiment of this application. An example in which the method is performed by an electronic device running a client supporting a virtual environment is used for description.

In a related technology, a flash direction of a flash skill in a mobile game can only be selected by a user, and a flash distance of the flash skill is fixed. In the mobile game, the user kills another virtual character by combining the flash skill and an initiation skill into a combo. When the initiation skill needs to be acted on the another virtual character, the user needs to adjust the flash direction of the flash skill, and pre-estimate a flash impact location based on the fixed flash distance, to hit the another virtual character.

For example, as shown in (a) in FIG. 2, the user performs active aiming on a casting direction of a flash skill by using a flash skill control 10, a direction that a player character 20 faces is the casting direction of the flash skill, and the user casts the flash skill after determining the casting direction of the flash skill. In this case, the player character 20 flashes to a flash impact location 50 according to a skill indicator 30, and a distance between the player character 20 and the flash impact location 50 is fixed. In a possible implementation, when a location of a virtual character 40 is the flash impact location 50, the player character 20 may successfully kill the virtual character 40 when flashing to the flash impact location 50 by using the flash skill. When the location of the virtual character 40 is not the flash impact location 50, the player character 20 cannot kill the virtual character 40. In this manner, when performing active aiming, the user needs to control the casting direction of the flash skill, and calculate a flash distance in advance. Therefore, the operation is difficult and a hit rate is low.

In view of the foregoing problem, an embodiment of this application provides a game skill casting method. When the user kills the virtual character 40 by combining the flash skill and another skill into a combo, operations of the user can be simplified, and a hit rate of killing the virtual character 40 by the user can be improved.

As shown in (b) in FIG. 2, with reference to (a) in FIG. 2, operations of the game skill casting method in this embodiment of this application are briefly described.

(1) Display the player character 20 and the virtual character 40 located in a virtual environment.

The player character 20 may be a virtual character controlled by a first user, and the virtual character 40 may be a player character controlled by another user, or a non-player character controlled by AI.

(2) Listen to an initiation skill, and determine a response manner of a flash skill after the initiation skill is triggered.

In some embodiments, the first user controls the player character 20 to combine the flash skill and the initiation skill into a combo to kill the virtual character 40.

In some embodiments, the initiation skill is a skill that is first casted by a user when using a combo, and is typically configured for opening a battle or initiating an attack. For example, the initiation skill may be at least one of a damage skill, a control skill, a directional skill, a directional movement skill, or a skill with another special effect. The first user needs to select and cast the initiation skill to start a combo.

In some embodiments, the initiation skill is added to a listening list. When the initiation skill is in a casting state, a program module corresponding to the initiation skill transmits a listening message to a program module corresponding to the flash skill. After receiving the listening message, the program module corresponding to the flash skill determines an operation manner of the user on the flash skill according to an operation of the first user.

In some embodiments, the flash skill is divided into two operation manners of quick casting and active aiming. The quick casting is an operation manner in which a flash direction and/or a flash impact location of the flash skill are/is not selected. The active aiming is an operation manner in which the flash direction and/or the flash impact location of the flash skill are/is selected. For example, the first user implements quick casting and active aiming of the flash skill by using the flash skill control 10.

In some embodiments, for a quick casting operation of a user, the flash skill has two response manners of a first response manner and a second response manner. The first response manner is a response manner of automatically searching a peripheral range 60 for the virtual character 40 (when there is a virtual character of an enemy camp), and the second response manner is a response manner of moving by a fixed length in a flash direction (when there is no virtual character of an enemy camp). The response manner of the flash skill is determined after the initiation skill is triggered.

(3) In the operation manner of quick casting, when the response manner of the flash skill is the first response manner, use a location of the virtual character 40 as a skill impact location 70.

After receiving the listening message, the program module corresponding to the flash skill determines whether the first user triggers the flash skill control 10. If the first user triggers the flash skill control 10, and an operation manner of the first user conforms to quick casting, the program module corresponding to the flash skill responds to the quick casting operation of the user, and the response manner of the flash skill is the first response manner, that is, automatically searching the peripheral range 60 for the virtual character 40, and the location of the virtual character 40 that conforms to a preset rule within the peripheral range 60 is used as the skill impact location 70.

In some embodiments, the preset rule refers to searching the peripheral range 60 for, according to a rule, the virtual character 40 meeting a condition.

For example, within the peripheral range 60, searching is performed according to a distance: selecting a virtual character 40 closest to the player character 20. This can ensure that the player character 20 can approach the virtual character 40 as soon as possible; and/or searching is performed according to an attribute value: comparing attribute values of virtual characters 40 within the peripheral range 60, and selecting a virtual character 40 having a lowest attribute value (for example, having a lowest health point). This can ensure that the player character 20 can first attack the virtual character 40 having the lowest attribute value, to increase a chance for killing the virtual character by the player character.

In some embodiments, the location of the virtual character 40 that conforms to the preset rule within the peripheral range 60 is used as the skill impact location 70, so that the player character 20 can directly flash to the skill impact location 70 when the first user triggers the quick casting operation, without selecting the casting direction of the flash skill. This manner greatly reduces operation difficulty of the first user, and improves a hit rate for the virtual character.

(4) Use the flash impact location 50 as a skill impact location when the operation manner of the flash skill does not belong to quick casting or the virtual character 40 meeting the condition does not exist within the peripheral range 60.

In some embodiments, when the first user uses the operation manner of active aiming, or the operation manner of flash skill is quick casting, the response manner of the quick casting is automatically searching the peripheral range 60 for the virtual character 40, and the virtual character 40 does not exist within the peripheral range 60, a location indicated by a trigger operation on the flash skill is still used as the skill impact location, that is, a flash direction of the player character 20 is a direction supported by a movable joystick or a direction that the player character 20 faces when receiving the casting operation on the flash skill. In this case, the flash impact location 50 is used as the skill impact location of the player character. A distance to the flash impact location 50 is fixed, and a direction of the flash impact location 50 is determined according to a direction selected by the first user. In some embodiments, the direction of the flash impact location 50 may be any direction on a plane.

The skill impact locations of the flash skill and the initiation skill may be considered as the same location.

(5) Restore the response manner of the flash skill from the first response manner to the second response manner after casting of the initiation skill in listening ends.

In some embodiments, after casting of the initiation skill in listening ends, the program module corresponding to the initiation skill transmits a listening message to the program module corresponding to the flash skill again, to notify the program module corresponding to the flash skill to control the flash skill to restore from the first response manner to the second response manner, that is, restore from the original response manner of searching the peripheral range 60 for the virtual character to the response manner of moving by a fixed length in the flash direction, and restore from using the location of the virtual character as the skill impact location of the initiation skill to using a location within a skill range of the flash skill as the skill impact location. In this case, the skill impact location of the initiation skill has a fixed distance.

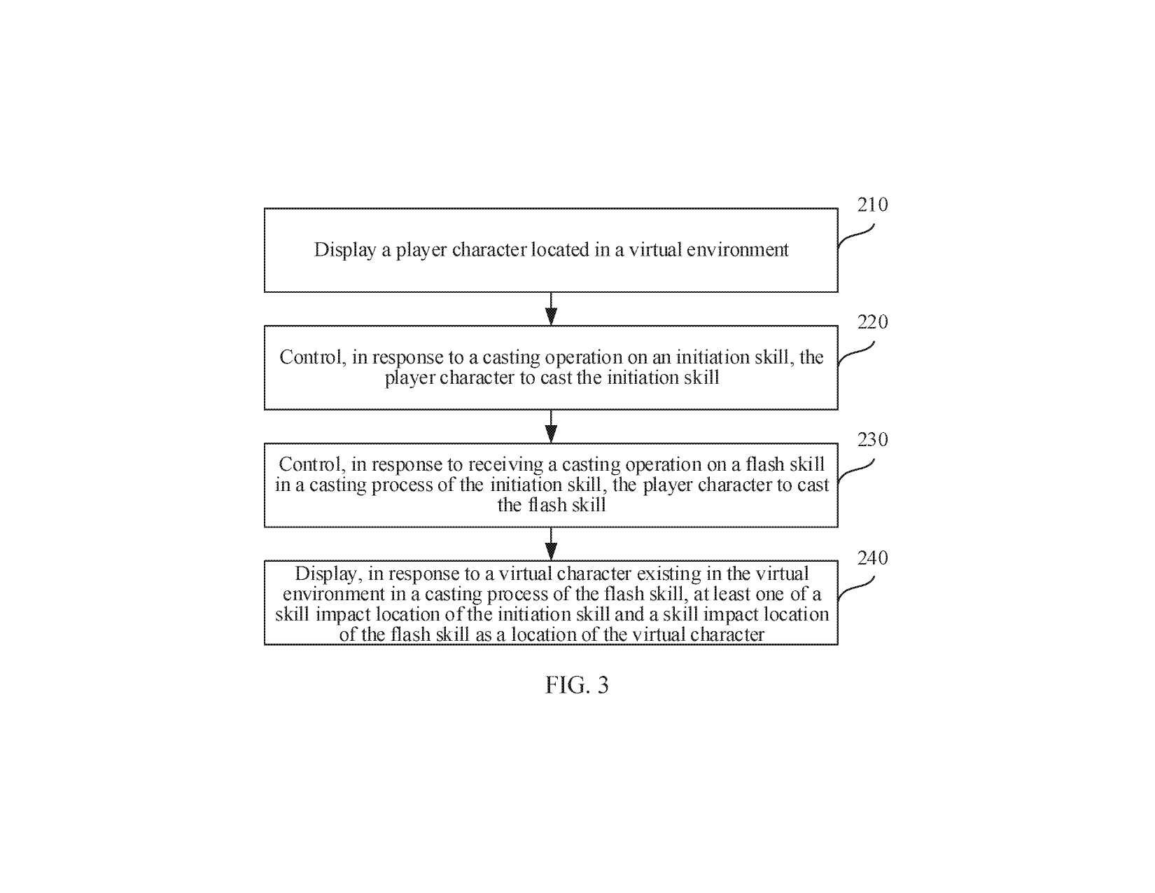

FIG. 3 is a first flowchart of a game skill casting method according to an exemplary embodiment of this application. An example in which the method is applied to the terminal 110 shown in FIG. 1 is used for description. The method includes the following operation 210, operation 220, operation 230, and operation 240.

Operation 210: Display a player character located in a virtual environment.

In some embodiments, a client supporting a virtual environment runs in a terminal device, and a player character located in the virtual environment is displayed on a game interface of the client.

In some embodiments, the player character is a virtual character controlled by a first user, and the first user plays a game or interacts with the virtual environment by controlling the player character. A first account logged in to by the first user by using the client has control permission on the player character.

In some embodiments, the player character is a character controlled by a player in a game. The player plays a game by operating a PC, to determine a movement, a decision, and a development direction of a character. The PC typically has unique personality, a background story, and a capability. The player may improve a capability of the PC and learn a story background of a game in manners such as interacting with an NPC, completing a task, and exploring the world in the game.

In some embodiments, the player character may be characters of different types in a game. For example, the player character is a mage character; the player character is an assassin character; or the player character is a marksman character. The foregoing example is merely an exemplary description, and a type of the player character is not limited in this application.

In some embodiments, the virtual environment further includes a virtual character. The virtual character may be a virtual character controlled by a game system, a virtual character controlled by AI, a virtual character controlled by another user, and/or a virtual character located at an enemy camp. This is not limited in this application.

In some embodiments, the virtual character may be a player character controlled through an operation on the client, may be artificial intelligence (AI) set in a virtual scene battle through training, or may be a non-player character (NPC) set in virtual scene interaction.

In the virtual environment, there are a plurality of manners of displaying the player character. For example, the manner of displaying the player character may be represented as displaying an appearance of the player character, including an image, clothes, equipment, and another visible element of the player character. Alternatively, the manner of displaying the player character may be represented as displaying an action of the player character, and the player character has corresponding actions in the virtual environment, configured for simulating behaviors such as walking, running, attacking, and defense of the player character. Alternatively, the manner of displaying the player character may be represented as displaying a state of the player character, for example, displaying energy, a level, a skill, and the like of the player character. The information may be presented by using numbers, icons, or in another form.

In some embodiments, the player character has an initiation skill and a flash skill.

In some embodiments, the first user controls the player character to combine the initiation skill and the flash skill into a combo to harm or kill the virtual character. For example, the combo means that the first user rapidly and continuously casts a plurality of skills in a game, to achieve a maximum damage output or control effect. The combo typically starts with an initiation skill. After casting the initiation skill, the first user typically rapidly selects and casts the flash skill when an action or an effect of the initiation skill has not ended.

In some embodiments, the initiation skill is a skill that is first casted by a user when using a combo, and is typically configured for opening a battle or initiating an attack. For example, the initiation skill may be at least one of a damage skill, a control skill, a directional skill, a directional movement skill, or a skill with another special effect. The user needs to select and cast the initiation skill to start a combo. The flash skill is a short-distance instant teleportation skill, allowing a virtual character controlled by a user to instantaneously move to a specified location, or instantaneously move by a preset distance length (for example, 500 yards in a game world). The combo means that a user rapidly and continuously casts a plurality of skills in a game to form a combined skill, to achieve a maximum damage output or control effect.

In an example, for the initiation skill, the player character uses Overload as the initiation skill and aims at an enemy hero and casts the initiation skill, causing magic damage and applying a mark to a target. Overload is a single skill with the highest damage in a combo of the player character, and is configured for opening a battle or initiating an attack.

In an example, for the flash skill, when being besieged by enemy heroes in a battle, the player character rapidly uses Sweeping Blade to perform a flash, instantaneously moving to a nearby friend unit or guard, to avoid an attack range of enemy skills and create an opportunity for a counterattack or escape.

In an example, for the combo skill, during laning, the player character uses Shuriken Toss as an initiation skill to toss a shuriken toward an enemy hero, causing damage and applying a mark to a target. Subsequently, the player character rapidly uses Shadow Dash to flash to a location behind the enemy hero, then uses Death's Dance to perform a finishing move, and finally uses Shadow Dash again to return to the original location, to complete a high-damage combo.

In some embodiments, a skill control is displayed on the game interface of the client, and the first user triggers a corresponding skill by using the skill control. For example, the skill control includes an initiation skill control and a flash skill control. The initiation skill control is configured to cast the initiation skill, and the flash skill control is configured to cast the flash skill.

In some embodiments, the skill control is an icon or a key configured for triggering or using a skill of a character in the game interface. A player clicks/taps or activates the control to execute a skill allocated to the player. The skill control is typically located below a game screen or in a particular interface region, to facilitate rapid access and use by a player in a battle or in a game.

In some embodiments, the initiation skill control is a control specially configured to cast the initiation skill. The skill is typically configured for initiating an attack, controlling an enemy, or creating a condition for a subsequent combo. In the game interface, the initiation skill control may be highlighted by using a special identifier or color, so that the player can quickly find and use the initiation skill control when the player needs the initiation skill control.

In some embodiments, the flash skill control is a control configured to cast the flash skill. Generally, this type of skill provides a short-distance instantaneous movement capability, to adjust a location of a character or escape an attack from an enemy. The flash skill control is crucial in a battle because the flash skill control may change a battlefield situation or provide an escape opportunity for a player. In the interface, the control may also have a special identifier, to distinguish from another skill control.

Operation 220: Control, in response to a casting operation on an initiation skill, the player character to cast the initiation skill.

In some embodiments, the casting operation is an operation configured for triggering or starting the initiation skill. For example, the casting operation has a plurality of operation manners, including at least one of operations such as a single-tap/click operation, a double-tap/click operation, and a long press operation.

In some embodiments, the casting operation is a series of actions performed by a player, to trigger or start a skill. Such an operation typically relates to interaction with the game interface, for example, clicking/tapping a skill control or pressing a keyboard shortcut key. The single-tap/click operation is the most basic casting operation manner, and a player clicks/taps a skill control or clicks a corresponding shortcut key once to cast a skill. This manner is applicable to instantly triggering a skill without an additional condition. The double-tap/click operation requires the player to quickly and successively tap/click a skill control or click a corresponding shortcut key twice to execute a skill. The double-tap/click operation is sometimes configured for executing a special skill combo or triggering a skill having a particular effect. The long press operation requires the player to continuously press a skill control or a corresponding shortcut key for a period of time. This manner is usually configured for charging and casting a skill, which may lead to enhancement of a skill effect, for example, increase a damage output or provide an additional effect. A dragging operation relates to a case in which the player presses a skill control and drags the skill control to a target location or direction to cast a skill. This manner is usually configured for a directional skill, and a player needs to accurately control a direction or a target of skill casting. A combination operation refers to that a player needs to sequentially perform a series of operations to cast a skill, for example, clicking/tapping a skill control first, and then quickly performing the double-tap/click operation or the long press operation. This manner is typically configured for a complex combo or skill combination.

In some embodiments, in response to the casting operation on the initiation skill, the player character is controlled to cast the initiation skill. The initiation skill is a skill that is first casted by the first user in a game, and is typically configured for starting a battle or initiating an attack. For example, the initiation skill may be at least one of a damage skill, a control skill, a directional skill, a directional movement skill, or a skill with another special effect. A type of the initiation skill is not limited in this application.

In an example, when the casting operation is a single-click operation, and the initiation skill is the damage skill, for example, Fireball, the player prepares to initiate an attack. A mouse pointer is moved to a "Fireball" skill control in a skill bar at the bottom of the screen, and then a left mouse button is clicked. In response to the single-click operation, the player character casts Fireball, a flame flies out from a hand of the player character and hits a nearest monster, to cause large range damage and apply a mark to an initiation action.

In an example, when the casting operation is a long press operation, and the initiation skill is the control skill, for example, Freeze, the player wants to preemptively use the control skill to limit a movement ability of a monster. The player long-presses a "Freeze" skill control in the skill bar. As the long-press continues, a charging effect of Freeze is enhanced, and Freeze is subsequently casted. A freezing ray shoots to a leader in a monster group, and freezes the leader in place, preventing movement of the leader and other monsters, and creating an opportunity for a subsequent action of the player character.

In some embodiments, the damage skill is a skill whose main objective is to cause damage to an enemy. Such a skill is typically configured for directly reducing a hit point of an enemy unit, for example, Fireball and Thundering. The damage skill may be single-level damage (damage is only caused to one target) or range damage (damage is caused to all enemies in a particular region).

In some embodiments, the control skill is a skill configured for limiting or controlling an action of an enemy unit, rather than directly causing damage. Such a skill includes Root, Stun, Silence, and the like, which can prevent enemies from moving, attacking, or casting skills, creating an attack or escape opportunity for a player.

In some embodiments, the directional skill is a skill that is casted toward a specified direction by using the player character as a start point, where a casting direction is the specified direction. The directional movement skill is a skill in which the player character moves toward a specified direction by using the player character as a start point, for example, a charge-type skill. The directional skill requires a player to specify a target to cast the skill. Such a skill typically requires a player to align a skill control to an enemy unit or a specific location and then cast the skill, for example, a single attack skill or a trap skill at a specific location. The directional movement skill is a skill that allows a character controlled by a player to instantaneously move to a specified target or location. Such a skill is typically configured for adjusting a location of a character, and may be jumping to a friend unit, an enemy unit, or a particular point on a map.

For example, the initiation skill of the player character is the charge-type skill. In a game, when the first user clicks/taps a control corresponding to the charge-type skill on a game interface, or presses a corresponding button on a physical handle, casting of the charge-type skill is triggered. In this case, the player character attacks a virtual character or causes a damage effect to the virtual character by using the charge-type skill.

In some embodiments, the special effect skill is a skill that has an indirect damage or control effect and provides another auxiliary or interference function. Such a skill may include a healing skill, a skill for providing a field of view, a skill for enhancing an attribute of the play character or a teammate, a skill for lowering an enemy capability, and the like. For example, some skills may provide a stealth effect, and other skills may provide a shield.

Therefore, when a player performs a casting operation on an initiation skill, the casting operation is immediately responded, and the player character is controlled to cast the initiation skill. This process not only improves real-time performance and interactivity of the game, but also enhances a sense of operation and battle satisfaction of the player. As the beginning of a battle, the use of the initiation skill can quickly cause damage to an enemy, apply a control effect, or adjust a battle layout, so that a first chance is won for the player, and an outcome of the game may be changed. In addition, successful casting of the initiation skill may further trigger a combo of subsequent skills, further amplifying a battle advantage of the player. Smoothness and an immediate effect of this skill casting have a significant positive impact on improving game experience and satisfaction of the player.

Operation 230: Control, in response to receiving a casting operation on a flash skill in a casting process of the initiation skill, the player character to cast the flash skill.

In some embodiments, the initiation skill is a skill that is continuously casted. An example in which the initiation skill is the directional movement skill is used. The player character moves by a distance in the virtual environment based on preset time, and a movement process of the player character in the preset time may be considered as a casting process of the directional movement skill. For example, the casting operation on the flash skill is received in the movement process of the player character, that is, the casting operation on the flash skill is received when an action or effect of the initiation skill has not ended.

In an example, during a middle term of the game, a player finds that an enemy middle laner is isolated and unsupported, and therefore determines to initiate an attack by using "Riven, the Exile". The player starts a casting process of "Riven, the Exile", and the player character starts to move toward a direction of the enemy middle laner. In a movement process of the player character, a teammate of the player character prompts the player character to use a flash skill to obtain a better attack location or avoid possible counterstrikes of enemies. The player character quickly responds in the casting process of "Riven, the Exile". The player character receives a casting operation on the flash skill when approaching the target and still moving. The player character immediately interrupts casting of "Riven, the Exile", and instantaneously moves to the enemy middle laner by using the flash skill. Because the player character is already close to the target in the movement process, use of the flash skill is not wasted, but an unexpected attack effect is achieved because of the continuous action of "Riven, the Exile". The player character then uses other skills to complete a combo, and successfully kills the enemy middle laner. In this example, the initiation skill "Riven, the Exile" of the player character is a skill that is continuously casted, and the flash skill is triggered in the casting process of the continuous skill. Use of the skill combination improves mobility and attack efficiency of the player character, and also exhibits flexibility and tactful of a skill casting operation in a game.

In some embodiments, the casting operation is an operation configured for triggering or starting the flash skill. For example, a virtual key is displayed on a touchscreen. The casting operation is at least one of operations such as a single-tap operation, a double-tap operation, a long press operation, and a swipe operation performed on the virtual key. Alternatively, the casting operation is an operation of pressing a specified button on a physical handle or a keyboard.

In some embodiments, the casting operation on the touchscreen is on the touchscreen. The casting operation typically relates to one or more of the following actions: a single-tap operation: A player lightly taps the virtual key on the screen once, to immediately trigger a skill; a double-tap operation: The player quickly and lightly taps the same virtual key on the screen twice continuously, to execute a special skill combo or move quickly; a long press operation: The player continuously presses the virtual key on the screen for a period of time, to start a skill with a special effect or charge a skill; and a swipe operation: The player swipes from a virtual key to another virtual key on the screen, or swipes in a direction, to trigger a specific skill or action.

In some embodiments, casting operation on a physical handle or a keyboard (Physical Controller or Keyboard Activation Operation): When the physical handle or the keyboard is used, the casting operation includes the following action: a press operation: A player presses a specified button on the handle or a specific key on the keyboard, to trigger a corresponding skill. The operation may be a simple single key press, or may be a combined key press. Hold operation: A player continuously presses a key without releasing the key, and the hold operation may be configured for executing a continuous skill or waiting for a particular effect of a skill to be triggered. Button combination operation: A player presses a plurality of buttons at the same time, configured for executing a complex skill combination or a special skill.

In some embodiments, in response to receiving the casting operation on the flash skill in the casting process of the initiation skill, the player character is controlled to cast the flash skill. After casting the initiation skill, the first user typically rapidly selects and casts the flash skill when an action or an effect of the initiation skill has not ended. The flash skill is a short-distance instant teleportation skill. After determining a skill impact location of the flash skill, the first user controls the player character to quickly move to the skill impact location of the flash skill by using the flash skill.

In an example, as a member of a team, a player is preparing to ambush an enemy and uses an initiation skill, that is, Flashbang, which is a throwing item that can temporarily blind the enemy. The player character throws Flashbang, and Flashbang flies to a location of the enemy along a preset track. At a moment when Flashbang is about to explode, the player notices that an enemy is approaching in an opposite direction, which may pose a threat to the team of the player. To quickly deal with this situation, the player immediately selects and performs a casting operation on a flash skill when an effect of Flashbang has not ended. The flash skill is a short-distance instant teleportation skill, and allows the player character to instantaneously move to a new location. The player quickly clicks a shortcut key (usually an F key) of the flash skill on a keyboard, and determines an impact location of the flash skill by using a mouse. In response to the operation, the player character instantaneously moves to a specified impact location of the flash skill, and successfully evades a line of sight of the enemy and a possible attack. This rapid movement not only keeps the player away from danger securely, but also provides a counterstriking opportunity for the player, so as to control a battlefield situation. In this example, a response speed of the player and flexible application of the skill are key, and use of the flash skill is rapidly completed when an action or an effect of the initiation skill has not ended. This shows agility and tactful of the player in the game.

In some embodiments, the first user controls the player character to combine the initiation skill and the flash skill into a combo to kill the virtual character. For example, at the beginning of a game, the first user controls a player character to cast an initiation skill to a virtual character. An example in which the initiation skill is a damage skill, after casting the initiation skill, the first user quickly triggers a flash skill. In this case, the player character flashes to a vicinity of the virtual character, and hits the virtual character by using the damage skill corresponding to the initiation skill.

In an example, the player character is an assassin who excels at melee combat and high burst damage. The player character is participating in a team cooperative battle with an objective of killing an enemy hero while ensuring safety of the player character. After the game starts, the player character is laning in a middle lane of a map, and an opponent of the player character is an enemy. The player character observes that the enemy has a short period of cooling time after casting a skill, which is a good chance to initiate an attack, and the player character determines to kill an enemy by using a combo. First, the player character uses an initiation skill, that is, Shuriken Toss, which is a directional skill, and the player character aims a dart at the enemy and tosses the dart. The dart flies through a battlefield, strikes the target, causes damage, and applies a mark to the enemy. Next, when an action of the Shuriken Toss skill has not ended, and the dart has not returned to the player character, the player character quickly triggers a flash skill, that is, Sumeru Rush. A flash skill shortcut key on a keyboard is clicked, and a flash impact location, that is, a vicinity of the enemy marked by the Shuriken Toss skill, is specified by using a mouse. In response to the operation, the player character instantly disappears at the same place and appears beside the enemy, completing movement of Sumeru Rush. In this case, because of a marking effect of the Shuriken Toss skill, the player character may immediately use an execute skill, that is, Shadow Dance, which is a strong melee attack and may cause a large amount of additional damage to the enemy. The combo of the player character is first using Shuriken Toss as the initiation skill, and then quickly flashing to the vicinity of the target and completing the kill by using Shadow Dance, which is performed very smoothly. Because the actions are quick and continuous, the enemy barely has time to react, and the player character successfully kills the enemy, gaining an advantage for a team of the play character. This example shows how the first user forms an effective combo by combining the initiation skill and the flash skill, to quickly kill the enemy character.

In this way, in a virtual environment, a player can control, by using a casting operation, a character to cast an initiation skill, to quickly launch an attack or control the situation. In this process, if the player determines to use a flash skill, a system immediately responds to this operation and controls the player character to move quickly, to achieve flexibility in a battle. Such a response mechanism not only improves real-time performance and interaction of a game, but also enhances a sense of operation and battle satisfaction of a player. The player may obtain a first chance in a game by using such a skill combination and a quick response, effectively breaking through enemy defense or avoiding danger, thereby improving survival and slaying efficiency. These factors work together to significantly improve game experience and overall satisfaction of the player.

Operation 240: Display, in response to a virtual character existing in the virtual environment in a casting process of the flash skill, at least one of a skill impact location of the initiation skill and a skill impact location of the flash skill as a location of the virtual character.

In some embodiments, operation 204 may be implemented in the following manner: displaying, in response to the virtual character existing in a circular region or a fan-shaped region whose distance to the player character is less than a distance threshold in the virtual environment in the casting process of the flash skill, at least one of the skill impact location of the initiation skill and the skill impact location of the flash skill as the location of the virtual character.

In an example, it is assumed that a player character fights against an enemy in an open world, and the player uses a flash skill. The skill allows the player to instantaneously move to any location within a particular distance. A location of the player character is a center point of a circular region, and a distance threshold is set to 10 meters. An enemy virtual character exists within the circular region, for example, a Goblin. When the player triggers the flash skill, a game system detects that the Goblin exists in the circular region, in a game interface, at least one of a skill impact location of an initiation skill or a skill impact location of the flash skill is displayed as a location of the Goblin. For example, if the player chooses to attack a nearest enemy by using an initiation skill, a skill impact location of the initiation skill is displayed at the location of the Goblin, and the player may accurately attack the Goblin.

In an example, a player character is fighting with a plurality of enemies in a narrow and long channel, and the player uses a flash skill having an effect of a fan-shaped region. The skill allows the player to instantaneously move in any direction in the fan-shaped region. A location of the player character is an end point of the fan-shaped region, and a distance threshold is also 10 meters. There are several enemies in the fan-shaped region, including one enemy located at an edge of the fan-shaped region. When the player triggers the flash skill, it is detected that an enemy exists in the fan-shaped region. In this case, in the game interface, a skill impact location of the flash skill may be displayed at a location of the enemy. The player may choose to move to a vicinity of the enemy, to use the enemy as a target of the initiation skill or perform a next tactical deployment.

In some other embodiments, operation 204 may be implemented in the following manner: displaying, in response to the virtual character existing in another shaped region determined by using the player character as a center in the virtual environment in the casting process of the flash skill, at least one of the skill impact location of the initiation skill and the skill impact location of the flash skill as the location of the virtual character, where the another shaped region is a shaped region other than the circular region or the fan-shaped region.

In an example, an example in which the another shaped region is a rectangular region is used, and it is assumed that a player character needs to trigger a special mechanism within a rectangular region in a game with complex terrain. The player uses a flash skill, and a casting region of the skill is a rectangle centered on the player character. An enemy virtual character exists within the rectangular region, for example, a stone giant standing in a corner of the rectangle. When the player triggers the flash skill, the game system detects that the stone giant exists in the rectangular region. In the game interface, at least one of a skill impact location of an initiation skill or a skill impact location of the flash skill is displayed at a location of the stone giant. The player may choose to set the skill impact location of the initiation skill to the location of the stone giant, to attack the stone giant or trigger the mechanism.

In an example, a polygonal region is used as an example. A player character is exploring a maze. A polygonal region exists inside the maze, and a special energy source exists inside the region. The player needs to enter the region by using a flash skill. A casting region of the flash skill of the player character is a polygon, which matches the polygonal region of the special energy source in the maze. An enemy virtual character exists within the polygonal region, for example, a flying monster. When the player triggers the flash skill, the system detects that the flying monster exists in the polygonal region. In the game interface, at least one skill impact location is displayed at a location of the flying monster. The player may choose to move a vicinity of the flying monster, or may directly use the flying monster as a target of an initiation skill.

In some embodiments, operation 204 may be implemented in the following manner: displaying, in response to the virtual character existing in the virtual environment in the casting process of the flash skill, the skill impact location of the initiation skill as the location of the virtual character, and displaying the skill impact location of the flash skill as a location whose distance to the virtual character is less than or equal to a distance threshold.

In some other embodiments, operation 204 may be implemented in the following manner: displaying, in response to the virtual character existing in the virtual environment in the casting process of the flash skill, the skill impact location of the initiation skill and the skill impact location of the flash skill as the location of the virtual character.

In some embodiments, that the virtual character exists in the virtual environment in the casting process of the flash skill may mean that the virtual character exists within a peripheral range of the player character in the casting process of the flash skill, and the peripheral range is a particular range around the player character. In some embodiments, the peripheral range is a hittable range that is determined by using the player character as a center. For example, the peripheral range is at least one of a circular region, a fan-shaped region, or another shaped region, and a specific size of the peripheral range varies according to settings of a game. For example, the peripheral range is a circular range with a player character as a center and a radius of R, where R is less than or equal to a fixed range length of a flash skill during flashing. In some embodiments, R is further related to a skill casting distance of an initiation skill.

In an example, the peripheral range refers to a region of a particular range set around a player character as a center in a game. Within the range, the player character may execute some skills and have an effect on enemies or targets in the region, for example, causing damage or applying a control effect. The peripheral range is typically configured for describing skills having a range effect, and may affect all targets within the range.

In an example, the peripheral range may be a region of various shapes, for example, a circular region, a fan-shaped region, or another irregular shape region. A specific shape depends on features of a game designer and a skill. Circular region: The peripheral range is a circular region centered on a player character with a radius of R. In the region, all targets located within the region may be affected by a skill. Fan-shaped region: The peripheral range is a fan-shaped region, typically starting from the front of a player character or an angle, and covering a particular range of an angle.

In an example, in a game, the radius R of the peripheral range is typically less than or equal to a fixed range length of a flash skill. This means that after using the flash skill, the player can ensure subsequent skill casting on a target within the peripheral range without exceeding an effective range of the skill. A specific size of R varies according to settings of a game, and different skills may have different peripheral ranges.

In the foregoing example, the radius R of the peripheral range is related to a skill casting distance of the initiation skill. For example, if a casting distance of an initiation skill is relatively short, a peripheral range may be correspondingly reduced, to ensure effective use and balance of the skill.

In an example, assuming that in a game, a range of a flash skill of a player character is 600 units, a radius R of a peripheral range may be set to 300 units or less, to ensure that after flashing, the player can safely use another skill within the peripheral range without exceeding the range of the flash skill. Such a design not only ensures practicality and effectiveness of a skill, but also maintains balance of a game.

In some embodiments, a virtual character that is found within a peripheral range of a player character according to a preset rule and that meets a condition is displayed on a game interface:

displaying a virtual character closest to the player character within the peripheral range; and

displaying a virtual character having a lowest attribute value within the peripheral range.

In some embodiments, a virtual character that meets the preset rule within the peripheral range is used as a target virtual character, and a location of the target virtual character is displayed as the skill impact location of the initiation skill.

In some embodiments, the skill impact location is a location or a region on which a skill actually takes effect after being casted. In some embodiments, the skill impact location may affect a hit rate and a damage effect of a skill.

In some embodiments, in a game, a peripheral range is first determined according to a current location of a player and a set rule of the game. The range is typically a circle, a fan shape, or a region of another shape centered on a player character, and a size of the range is determined by a game mechanism. All enemy virtual characters within the peripheral range are traversed, and current locations and attribute value information of the enemy virtual characters are collected. The information may include, but is not limited to, a health point, attack power, defense power, and the like. In a game interface, a distance between each enemy virtual character and the player character is calculated, and a virtual character closest to the player character is found. Then, in the game interface, a location of the virtual character is displayed on a map by using a highlighted mark, an icon, or another visual indication manner. An attribute value of each enemy virtual character is evaluated, to find a virtual character having a lowest attribute value. Similarly, in the game interface, a location of the virtual character is displayed by using a highlighted mark, an icon, or another visual indication manner. One or more virtual characters that meet a condition are determined as the target virtual character. These rules may include preferentially considering a virtual character having a closest distance and a virtual character having a lowest attribute value, or performing determining according to other game logic (for example, an enemy threat level and a skill effect).

In some embodiments, the skill impact location is a location or a region on which a skill actually takes effect after being casted in a game. The location is a core point of a skill effect range and typically determines a hit rate, a damage effect, and another possible effect of a skill. The skill impact location may be a single target point, or may be a region, which specifically depends on a design and a feature of a skill. The skill impact location is crucial to tactical execution. For a single skill, a skill impact location is typically a specific location of an enemy unit, for example, a center point of an enemy. For a range skill, the skill impact location may be a region around a skill casting point, for example, a circle, a fan shape, or a region of another shape centered on the casting point. In the foregoing embodiments, when a virtual character (for example, an enemy) exists within a peripheral range of a player character in a process of casting a flash skill, skill impact locations of an initiation skill and the flash skill are displayed in a game. That the skill impact location of the initiation skill is displayed at a location of the virtual character means that the initiation skill uses the virtual character as a target point or a target region. The skill impact location of the flash skill is also displayed at the location of the virtual character, indicating that the player character moves to the location after flashing. A display mechanism of a skill impact location enables a player to clearly know a location on which a skill takes effect, thereby making an accurate tactical decision. For example, if a player hopes to hit an enemy by using an initiation skill, and adjust a location by using a flash skill, the game interface helps the player determine a skill impact location, to ensure that the skill can effectively act on the enemy, thereby improving a hit rate and maximizing a damage effect.

In some embodiments, when the first user controls the player character to continuously cast a plurality of skill combinations to form a combo, a skill impact location may be considered as a skill impact location of an initiation skill; or considered as a skill impact location of a flash skill; or considered as a skill impact location of the combo. When the initiation skill is a directional movement skill, the skill impact location may alternatively be considered as an impact location of the player character after moving.

In this application, an example in which the skill impact location is the skill impact location of the initiation skill is used for description.

For example, a player character is a wizard-type character, and an initiation skill of the player character is throwing a fireball to a virtual character. After the first user triggers a control of the initiation skill, an action of throwing the fireball to the virtual character by the player character is displayed on the game interface. When the action of throwing the fireball or an effect of throwing the fireball has not ended, the first user quickly selects and triggers a skill control of a flash skill. In this case, the player character instantaneously flashes to a location of the virtual character, and a skill impact location is a location at which the fireball finally explodes, that is, the location of the virtual character.

In an example, a player character waits for an occasion in a team fight, and the player notices that an enemy attack damage carry (ADC, mainly responsible for dealing damage) is standing front, and is isolated and unsupported. The player character determines to use a flash skill "Sweeping Blade" to approach the enemy ADC, and then use an initiation skill "Wind Slash" to kill the enemy ADC. The player character starts a casting operation on the flash skill "Sweeping Blade" and selects the enemy ADC as a target point. In a process of casting the flash skill, the player character moves to the enemy ADC, and in this case, the enemy ADC is within a peripheral range of the player character. The game interface immediately performs a response and displays a skill impact location of "Wind Slash", and the location is exactly a location of the enemy ADC. Generally, the impact location is displayed on a game map by using a cursor or a special mark. In addition, the game interface also displays a skill impact location of Sweeping Blade, that is, a location to be reached by the player character, and the location is also represented on the map by using a mark or an animation effect. When Sweeping Blade is about to be completed, the player character quickly performs a casting operation on Wind Slash. Because the enemy ADC is located within the peripheral range of the player character, the player character can ensure that Wind Slash accurately hits the target. The player character instantaneously moves to a vicinity of the enemy ADC by using the flash skill, and then casts Wind Slash, causing a large amount of damage. If Wind Slash hits the enemy ADC with sufficient damage, the player character successfully kills the enemy ADC. In this example, both the skill impact locations of the flash skill and the initiation skill of the player character are displayed at the location of the enemy ADC. In this way, the player character can accurately control skill casting, to ensure that the player character can effectively attack the target, thereby obtaining an advantage in a battle.

Based on the foregoing, this embodiment of this application provides a game skill casting method. In response to a casting operation on an initiation skill, a player character is controlled to cast the initiation skill in a virtual environment. In response to receiving a casting operation on a flash skill in a casting process of the initiation skill, the player character is controlled to cast the flash skill in the virtual environment, and a user does not need to adjust a casting direction and a casting distance of the flash skill in a process of casting the flash skill; and a location of a virtual character within a peripheral range is used as skill impact locations of the flash skill and the initiation skill. This manner simplifies operations of the user and also improves a hit rate of the player character.

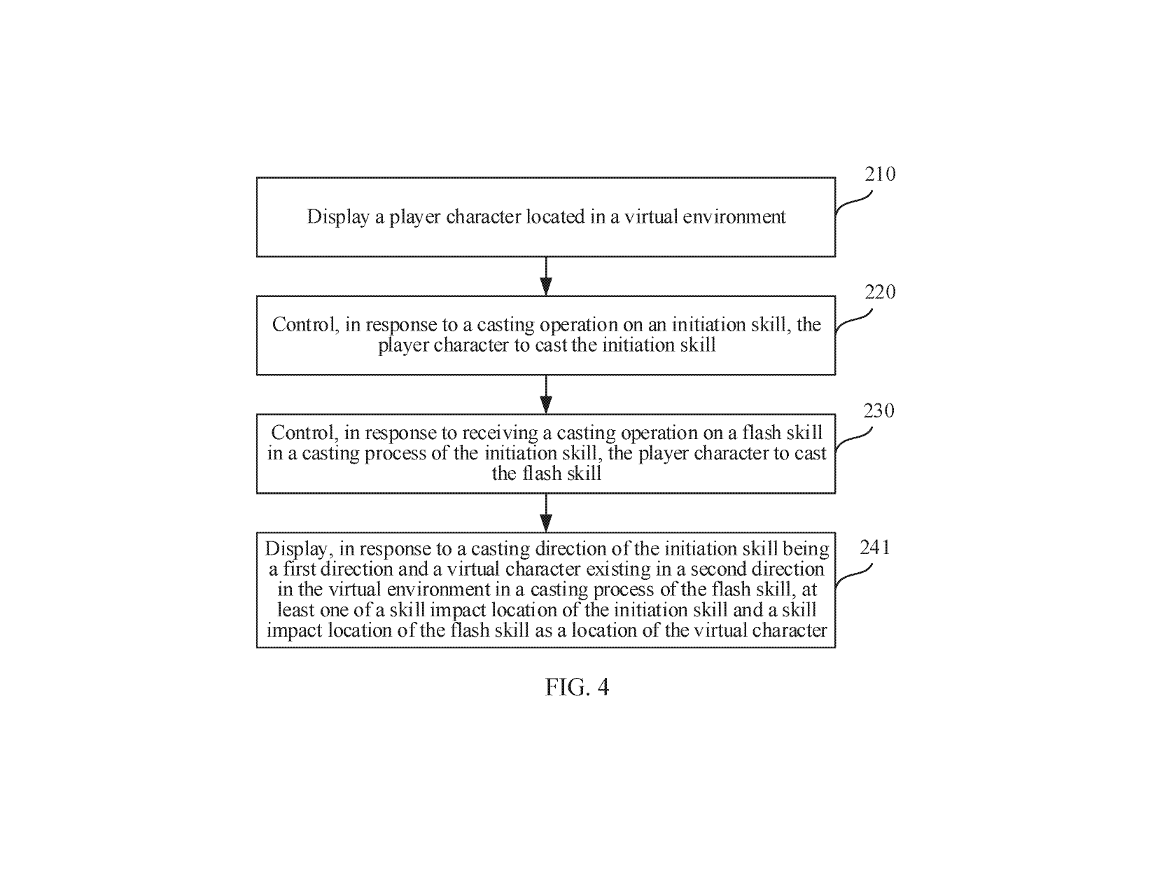

In some embodiments, the initiation skill is a directional skill, the initiation skill has a casting direction, and the virtual character exists within the peripheral range of the player character. As shown in FIG. 4, FIG. 4 is a second flowchart of a game skill casting method according to an exemplary embodiment of this application. Operation 240 may be replaced with the following sub-operation.

Operation 241: Display, in response to a casting direction of the initiation skill being a first direction and the virtual character existing in a second direction in the virtual environment in the casting process of the flash skill, at least one of the skill impact location of the initiation skill and the skill impact location of the flash skill as the location of the virtual character.

In some embodiments, the first direction and the second direction are different directions.

In some embodiments, the first direction is a casting direction of the initiation skill, and the second direction is a direction of the virtual character relative to the player character within the peripheral range.

In some embodiments, the initiation skill is a directional skill, and the directional skill is a skill that the first user needs to select a target direction or location to cast.

In some embodiments, the first direction is an initial direction when a player character casts an initiation skill in a game. The direction is typically specified by the player by using an input device such as a mouse click, a key, or a joystick, and determines a casting path or a target of the initiation skill.

In some embodiments, the second direction is a direction of a virtual character (for example, an enemy unit or a target) existing within a peripheral range of a player character relative to the player character in a process in which the player character casts a flash skill in the game. The direction is relative to the first direction, and describes a location relationship of the virtual character around the player character.

In some embodiments, the directional skill is a skill that a player needs to selects a target direction or location to cast. Such a skill typically requires a player to accurately control a casting direction of the skill, to ensure that the skill can correctly act on a target or a target region.

In an example, it is assumed that in a virtual battle game, a character controlled by a player is an archer, and a first direction is that the player clicks a point on a screen by using a mouse, to cast an initiation skill, that is, Arrow Storm. The clicked point represents a casting direction of the Arrow Storm skill, that is, the first direction. Arrow Storm may fly along a direction specified by the player, causing damage to enemies on the path. A second direction is that in a process in which the player casts the Arrow Storm skill, the player moves rapidly by using a flash skill, that is, Wind Walk. In this case, an enemy unit appears within a peripheral range of the player character. The location relationship between the enemy unit and the player character is the second direction. Directional skill: Arrow Storm is a directional skill because the player needs to select a direction to cast the skill. The player needs to point to an enemy unit or predict a movement direction of an enemy to cast Arrow Storm, so as to hit the target. Display of a skill impact location: After both a casting direction (the first direction) of the Arrow Storm skill and a movement direction (the second direction) of Wind Walk are determined, impact locations of the two skills are displayed on the game interface. For Arrow Storm, the impact location may be displayed in a direction specified by the player. For Wind Walk, the impact location is displayed close to a location of the enemy unit within the peripheral range of the player character. In this way, the player can intuitively see how the skills work on a battlefield, and adjust tactics accordingly.

In this way, a player is allowed to consider a first direction and a second direction while casting an initiation skill, and a corresponding skill impact location is displayed according to a location of a virtual character in a casting process of a flash skill, which improves operation flexibility of the player and tactical diversity, so that the player can more accurately and rapidly make a decision in a battle. The first direction is used as a casting direction of the initiation skill, allowing the player to plan an attack path in advance, and the second direction provides a real-time response opportunity, so that the player can adjust a policy according to dynamic locations of surrounding enemies. The impact locations of the initiation skill and the flash skill are displayed, so that the player can clearly learn how the skills affect a battlefield, thereby improving a hit rate of the skills, optimizing a use effect of a skill combination, and achieving an advantage in a tense battle. This mechanism not only enhances immersion and satisfaction of the player, but also facilitates game playability and fairness because this mechanism provides equal opportunities for all players to practice and master this advanced operation skill.

In some embodiments, the initiation skill is a directional skill, and the first user controls the initiation skill to be casted in the first direction. In a process of casting the initiation skill in the first direction (a skill effect or a skill action of the initiation skill has started but has not ended), the first user triggers casting of the flash skill. In this case, the peripheral range of the player character is searched for a virtual character, and the virtual character exists in the second direction within the peripheral range of the player character. In this case, a casting direction of the flash skill is the second direction of the virtual character. A casting direction of the initiation skill changes from the first direction to the second direction, and a location of the virtual character is a skill impact location of the initiation skill.

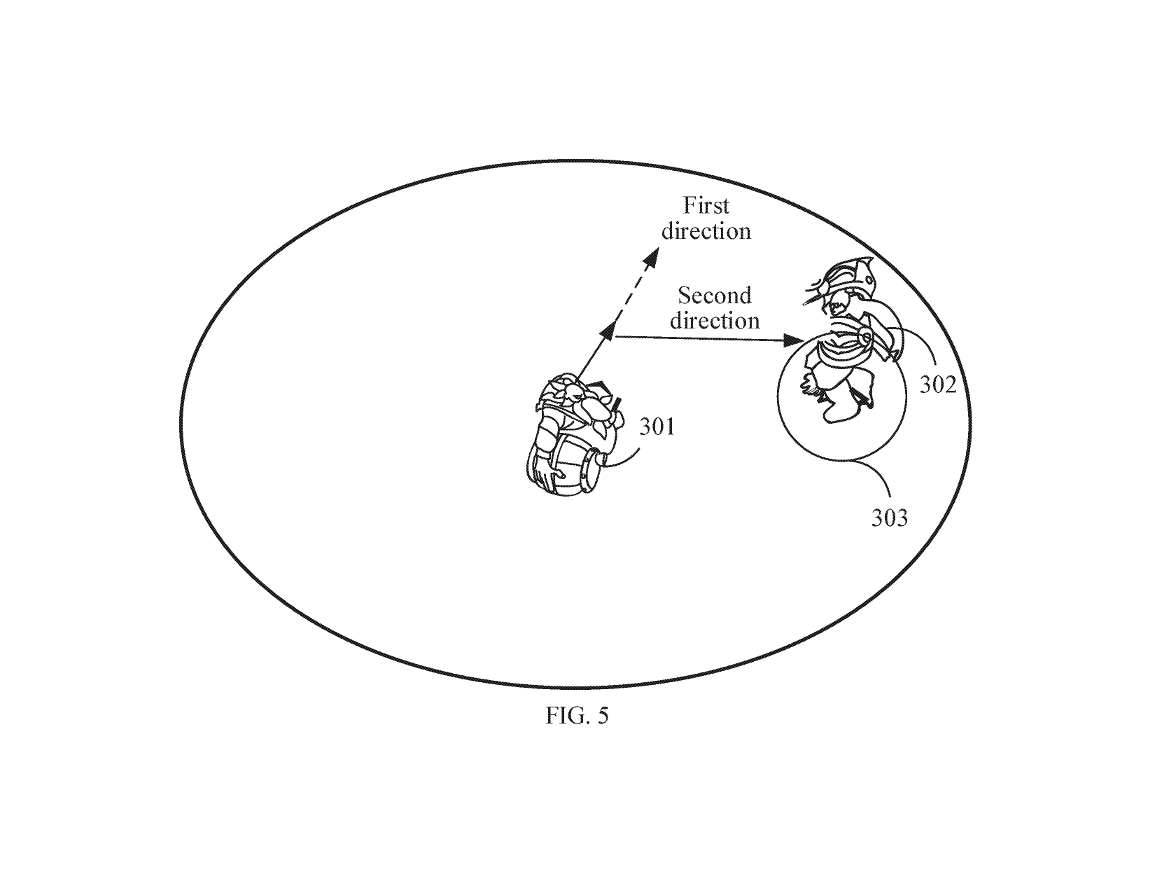

For example, as shown in FIG. 5, FIG. 5 is a second schematic diagram of a principle of a game skill casting method according to an exemplary embodiment of this application. A casting direction of an initiation skill of a player character 301 is a first direction. In a process of casting the initiation skill in the first direction, a first user triggers the player character 301 to cast a flash skill. A virtual character 302 exists in a second direction within a peripheral range of the player character. In this case, a casting direction of the flash skill is the second direction, the casting direction of the initiation skill changes from the first direction to the second direction, and a location of the virtual character 302 within the peripheral range is an impact location 303 of the initiation skill.

In a MOBA game, a movement wheel control located on a left hand side is typically configured to control a movement of a player character. In the casting process of the flash skill, the user does not need to control the movement wheel control, or the user controls, by using the movement wheel control, the player character to face the first direction. However, a client still controls the skill impact location of the initiation skill as the location of the virtual character, to reduce operation complexity for the user. That is, in this case, a direction on the movement wheel control is not considered for the flash skill.

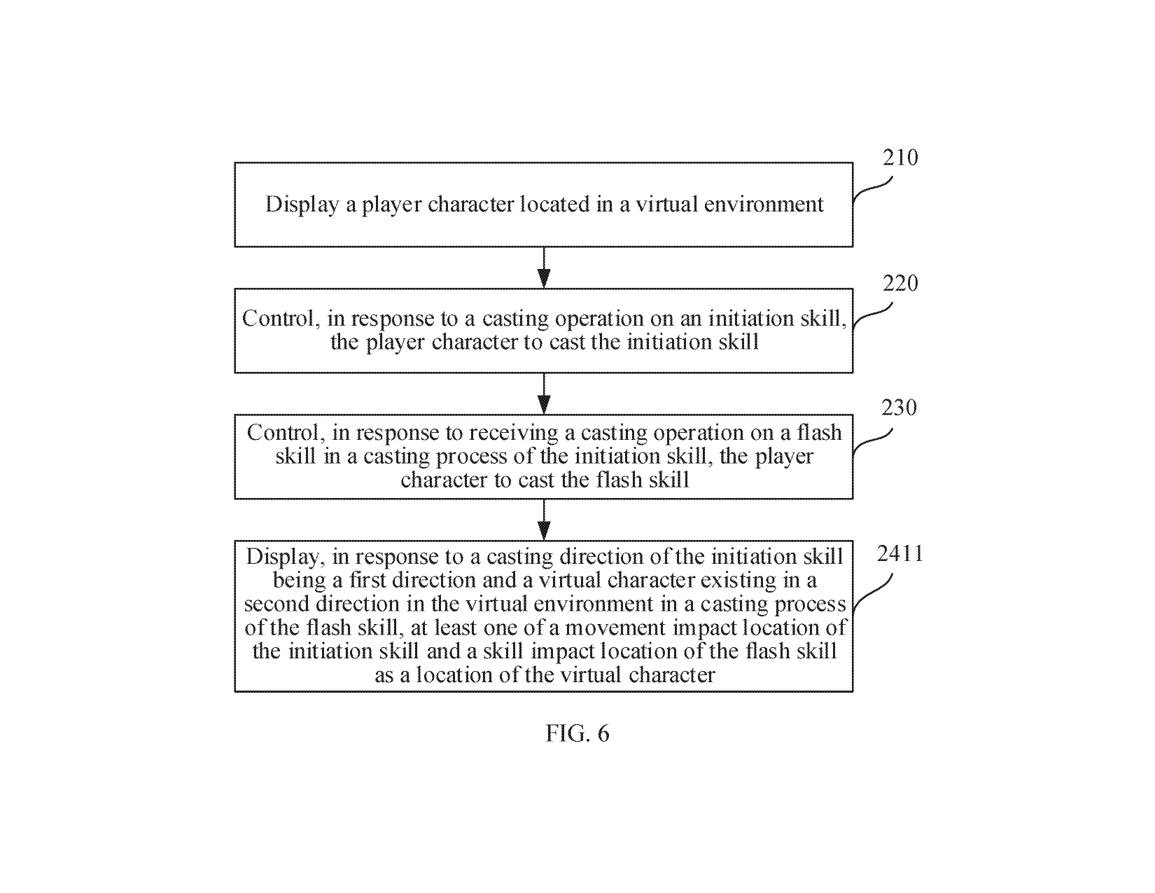

In some embodiments, the initiation skill is a directional movement skill, the initiation skill has a default movement length, and the virtual character exists within the peripheral range of the player character. As shown in FIG. 6, FIG. 6 is a third flowchart of a game skill casting method according to an exemplary embodiment of this application. Operation 241 may be replaced with the following sub-operation.

Operation 2411: Display, in response to a casting direction of the initiation skill being a first direction and the virtual character existing in a second direction in the virtual environment in the casting process of the flash skill, at least one of a movement impact location of the initiation skill and the skill impact location of the flash skill as the location of the virtual character.

In some embodiments, the first direction and the second direction are different directions, and a movement distance of the initiation skill is different from the default movement length.

The first direction is a casting direction of the initiation skill, and the second direction is a direction of the virtual character relative to the player character within the peripheral range.

In some embodiments, the initiation skill is a directional movement skill, and the directional movement skill has a default movement length. When the first user uses the initiation skill with directional movement, the player character moves from a current location to a location within the default movement length, where the default movement length is a preset movement length.

In some embodiments, the movement impact location is a location at which the player character finally stays after using the directional movement skill. For example, the movement impact location may be a preset target location, or may be a location obtained according to casting of the directional movement skill.

In some embodiments, the initiation skill is a directional movement skill. the first user controls the initiation skill to be casted in the first direction. A virtual character exists within the peripheral range of the player character, and the virtual character is in the second direction of the player character. In a process of casting the initiation skill in the first direction (a skill effect or a skill action of the initiation skill has started but has not ended), the first user triggers the flash skill. The flash skill is casted in the second direction, the casting direction of the initiation skill also changes from the first direction to the second direction, and the movement impact location of the initiation skill is a location of the virtual character.

In some embodiments, the directional movement skill is a special initiation skill that allows a player to specify a direction or a location in a game and enables the player character to move to the direction or the location. Such a skill has the following features: having a default movement length: The directional movement skill has a preset movement distance, that is, a default movement length. The length is preset and cannot be changed by a player. Default movement: When a player uses a directional movement skill, a character moves to a location within a default movement length. The location is determined by both a direction when the skill is casted and a default movement length.

In some embodiments, the movement impact location is a location at which the player character finally stays after using the directional movement skill. The location may be one of the following two cases: a preset target location: When casting a directional movement skill, a player may specify a target location, and the movement impact location is a final staying point after the player character moves to the target location. Location obtained according to casting of a directional movement skill: In some games, the directional movement skill may have a particular behavior or effect, for example, perform complex path planning. In this case, the movement impact location is calculated by using the skill, rather than being directly specified by the player.

In some embodiments, in a game, a player uses a directional movement skill to avoid an attack of an enemy. The player clicks/taps a location of the enemy on a screen as a target, and the player character is moved to a default movement length corresponding to the clicked location by using a Sumeru Rush skill, and a location on which the player finally stays is a movement impact location.

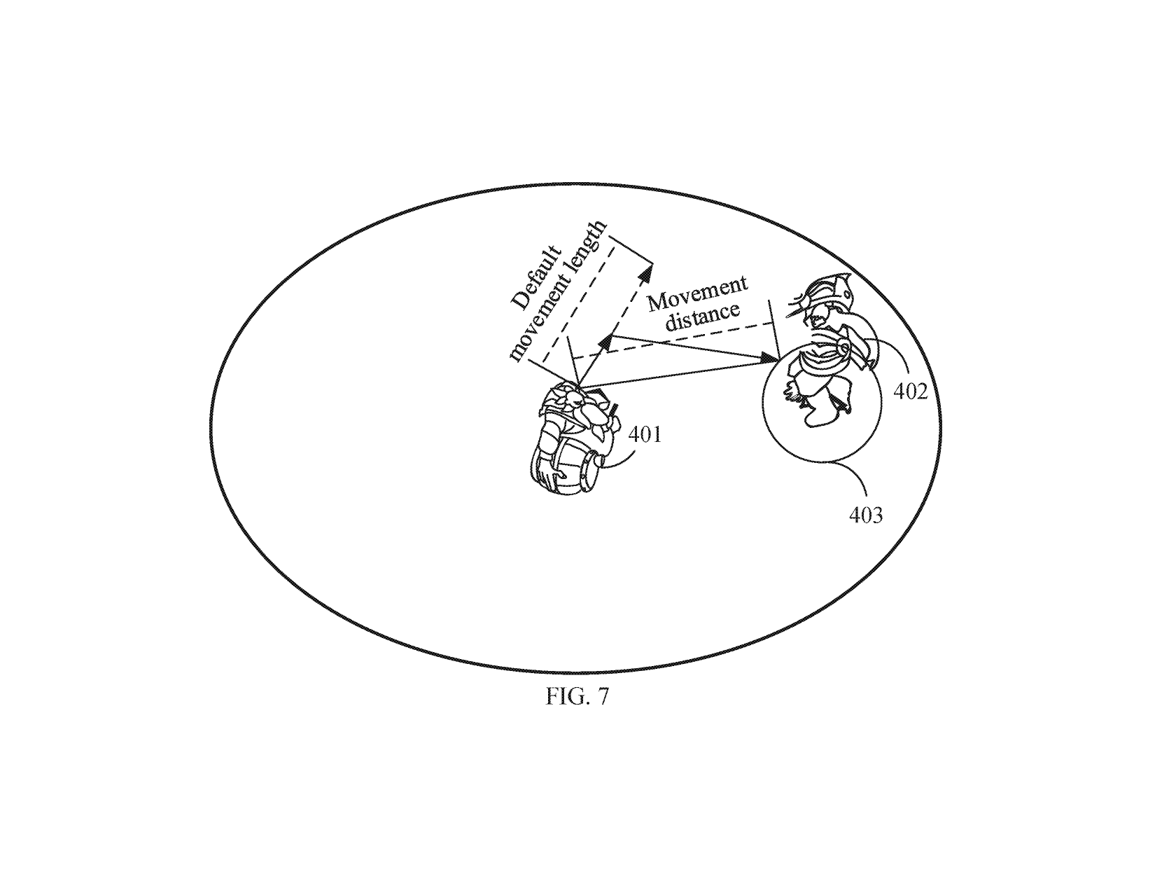

For example, as shown in FIG. 7, FIG. 7 is a third schematic diagram of a principle of a game skill casting method according to an exemplary embodiment of this application. A casting direction of an initiation skill of a player character 401 is a first direction, and a default movement length of the initiation skill is a preset length. In a process of casting the initiation skill in the first direction, a first user triggers the player character 401 to cast a flash skill. A virtual character 402 exists in a second direction within a peripheral range of the player character. In this case, a casting direction of the flash skill is the second direction, the casting direction of the initiation skill changes from the first direction to the second direction, a movement distance of the initiation skill is an actual movement distance of the player character 401, and a default movement length of the initiation skill is different from the actual movement distance. In this case, a location of the virtual character 402 within the peripheral range is a movement impact location 403 of the initiation skill.

Based on the foregoing, according to the method provided in this embodiment of this application, in a possible implementation, the initiation skill is a directional skill, and in response to a casting direction of the initiation skill being a first direction and the virtual character existing in a second direction within the peripheral range of the player character, the skill impact location of the initiation skill is displayed as the location of the virtual character. The initiation skill is a directional movement skill having a default movement length, a movement impact location of the initiation skill is displayed as the location of the virtual character, the first direction and the second direction are different directions, and a movement distance of the initiation skill is different from the default movement length. When the initiation skill is the directional skill, the impact location of the initiation skill is also determined according to the location of the virtual character.

In a MOBA game, a movement wheel control located on a left hand side is typically configured to control a movement of a player character. In the casting process of the flash skill, the user does not need to control the movement wheel control, or the user controls, by using the movement wheel control, the player character to face the first direction. However, a client still controls the skill impact location of the initiation skill as the location of the virtual character, to reduce operation complexity for the user. That is, in this case, a direction on the movement wheel control is not considered for the flash skill.

• Display a virtual character closest to the player character within the peripheral range.

In some embodiments, the virtual character is an enemy virtual character closest to the player character within the peripheral range, and the location of the virtual character is used as the skill impact location of the initiation skill.

In some embodiments, the enemy virtual character is a virtual character belonging to a current enemy camp of a player in a game world, and is typically an enemy non-player-controlled character (NPC) or an enemy player character. The enemy virtual character is a virtual character having an enemy relationship with the player character within the peripheral range of the player character. These characters may be characters of other players, or may be enemy NPCs in a game. That the enemy virtual character and the player character have an enemy relationship means that the enemy virtual character and the player character may have a direct fight conflict with each other, and the player is motivated to attack or beat these enemy characters to obtain an advantage in a game.

In an example, in a multiplayer online battle game, if a player character is located in a corner and there are a plurality of enemy units around the player character, an enemy virtual character within a peripheral range of the player character is an enemy unit closest to the player character. The enemy virtual character may be a main character that needs to be considered when the player plans a next tactical operation.

In some embodiments, the virtual character is an enemy virtual character other than the player character controlled by the first user in the virtual environment, for example, a virtual character controlled by a second user, or a virtual character controlled by AI.

In some embodiments, there may be one or more virtual characters within the peripheral range.

In a possible implementation, if the virtual character exists within the peripheral range of the player character, and one virtual character exists within the peripheral range of the player character, a location of the virtual character is used as the skill impact location of the initiation skill.

In a possible implementation, if the virtual character exists within the peripheral range of the player character, and a plurality of virtual characters exist within the peripheral range of the player character, a virtual character closest to the player character in the plurality of virtual characters is determined as a target virtual character, and a location of the target virtual character is determined as the skill impact location of the initiation skill.

In some embodiments, searching is performed within the peripheral range according to a distance, and a virtual character closest to the player character within the peripheral range is used as a target virtual character. This manner can ensure that the player character can preferentially attack a closest virtual character, thereby more effectively casting a skill to the virtual character, and improving a hit rate of the player character for the virtual character.

Display a virtual character having a lowest attribute value within the peripheral range.

In some embodiments, the virtual character is an enemy virtual character having a lowest attribute value within the peripheral range, and the location of the virtual character is used as the skill impact location of the initiation skill.

In some embodiments, the attribute value is a value expression of a particular attribute owned by a virtual character in a game, and is configured for describing various features and capabilities of the virtual character in the game. For example, the attribute value includes at least one of a health point, attack power, defense power, and the like of a virtual character.

In some embodiments, attribute value: The attribute value is a value expression of a particular attribute of a virtual character in a game. These attribute values are configured for describing various features and capabilities of a virtual character, and are a basis for game balance and character capability evaluation. Common attribute values include, but are not limited to, a health point (HP), attack power, defense power, magic resistance, and the like.

An example in which the attribute value of the virtual character is the health point is used for description.

For example, a health point of a virtual character indicates an ability of the virtual character to bear damage. A life state is determined by using the health point of the virtual character. A lower health point of the virtual character indicates a higher possibility of defeating the virtual character.

In some embodiments, the health point of the virtual character is displayed on a game interface in a numerical manner. For example, the health point may represent a current remaining health point of the virtual character by using a value. Alternatively, the health point of the virtual character may be displayed on the game interface in a manner of a progress bar. For example, the health point may represent a current remaining health point of the virtual character by using a health bar. Alternatively, the health point of the virtual character is displayed on the game interface by combining a numerical value and a progress bar. A value or a health bar of the health point varies according to a state and an attribute of the virtual character, for example, when the virtual character is damaged, the value or the health bar of the health point is reduced.

In an example, each enemy virtual character has an attribute value. For example, a health point of an enemy virtual character A is 100, attack power is 30, and defense power is 20. A health point of an enemy virtual character B is 150, attack power is 40, and defense power is 30. A health point of an enemy virtual character C is 120, attack power is 25, and defense power is 25. A health point of an enemy virtual character D is 80, attack power is 50, and defense power is 10. Virtual character having a lowest attribute value within the peripheral range: In the foregoing enemy virtual characters, the enemy virtual character D has the lowest health point. Therefore, the enemy virtual character D is a virtual character having the lowest attribute value within the peripheral range. A player determines to attack the virtual character having the lowest attribute value, that is, the enemy virtual character D, by using an initiation skill. The player uses a location of the enemy virtual character D as a skill impact location of the initiation skill. The game interface displays the impact location, and the player character subsequently casts the initiation skill, and attacks the enemy virtual character D by using the location of the enemy virtual character D as a target, to attempt to defeat the enemy virtual character D.

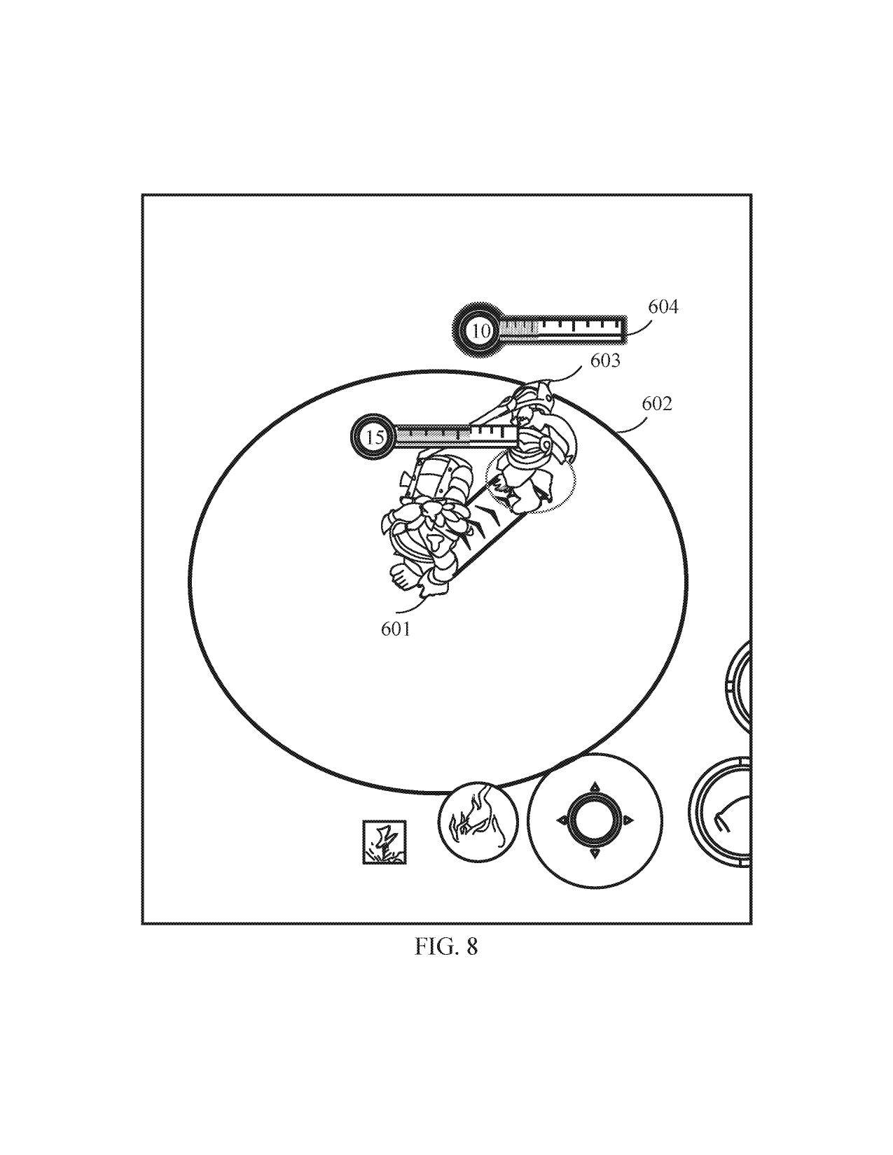

For example, as shown in FIG. 8, FIG. 8 is a fourth schematic diagram of a principle of a game skill casting method according to an exemplary embodiment of this application. In a virtual environment, a virtual character 603 exists in a peripheral range 602 of a player character 601. An attribute value of the virtual character 603 may be represented by using a visual health point 604, and the visual health point 604 represents a current attribute value of the virtual character 603 by combining a numerical value and a progress bar.

In some embodiments, there may be one or more virtual characters within the peripheral range.

In a possible implementation, if the virtual character exists within the peripheral range of the player character, and one virtual character exists within the peripheral range of the player character, a location of the virtual character is used as the skill impact location of the initiation skill.

In a possible implementation, if the virtual character exists within the peripheral range of the player character, and a plurality of virtual characters exist within the peripheral range of the player character, a virtual character having a lowest attribute value in the plurality of virtual characters is determined as a target virtual character, and a location of the target virtual character is determined as the skill impact location of the initiation skill.

Based on the foregoing, according to the method provided in this embodiment of this application, in response to a virtual character existing within a peripheral range of a player character, a virtual character that is found within the peripheral range of the player character by using a preset rule and that meets a condition is displayed, a virtual character closest to the player character is displayed within the peripheral range as a target virtual character, or a virtual character having a lowest attribute value is displayed within the peripheral range as a target virtual character, and a location of the target virtual character is used as a skill impact location of an initiation skill. Selecting the closest virtual character as the target virtual character can ensure that the initiation skill preferentially attacks the closest virtual character, and selecting the virtual character having the lowest attribute value as the target virtual character can ensure that the initiation skill preferentially attacks the virtual character having lowest energy, thereby improving a hit rate of the player character attacking the virtual character.

The flash skill has two operation manners.

In some embodiments, the flash skill is a directional skill, and the flash skill has two operation manners of quick casting and active aiming. The first user may control, in different operation manners of triggering the flash skill, skill impact of the initiation skill of the player character at different locations.

The flash skill is casted in two operation manners by using a flash skill control:

Quick casting

Active aiming

In some embodiments, a flash skill control is displayed on the game interface, and the flash skill control is configured to trigger a player character to cast a flash skill. For example, the first user may cast the flash skill of the player character by triggering the flash skill control. For example, the flash skill control is displayed in any form, for example, a circle, a square, or in another form.

An example in which a form of the flash skill control is the circle is used. In this case, the flash skill control is displayed in a form of a circular key on a touchscreen, and after the first user long presses and triggers the circular key, the flash skill control is displayed in a form of a sliding wheel.

For example, the form of the flash skill control in an initial state is a form of a circular key, and the first user may directly trigger the operation manner of quick casting of the flash skill by tapping the circular key. The first user does not need to select a flash direction of the player character. If there is a virtual character within the peripheral range, the flash direction is toward the virtual character. If there is no virtual character within the peripheral range, the flash direction is determined by a facing direction of the player character when the player character receives a casting operation on the flash skill.

It is assumed that a region in which the circular key is located on the flash skill control is a first region, and an outer ring part other than the first region is a second region (also referred to as a wheel region). A finger of the first user long presses the first region or directly presses an interface of the second region to activate the form of the sliding wheel. The flash skill control includes a wheel region and a joystick region in a form of a sliding wheel. A flash direction of the flash skill is determined by using an impact point to which the joystick region points within the wheel region. The first user may control the flash direction of the player character by controlling the joystick region. The first user may select the flash direction of the flash skill by sliding the joystick region, and loosen the finger to trigger casting of the flash skill, that is, trigger the operation manner of active aiming of the flash skill.

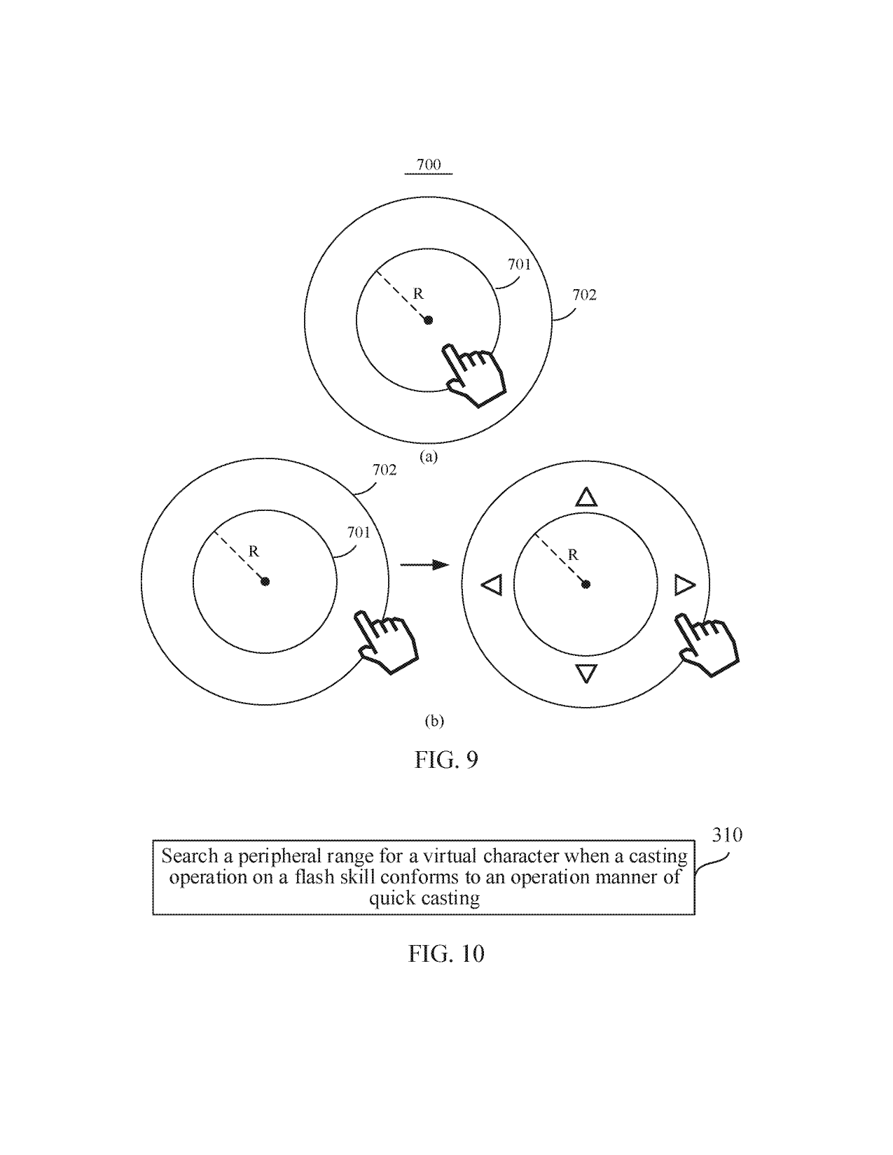

Referring to FIG. 9, FIG. 9 is a fifth schematic diagram of a principle of a game skill casting method according to an exemplary embodiment of this application. In a flash skill control 700, as shown in (a) in FIG. 9, a region with a preset radius of R is a first region 701. In the first region 701, the first user randomly clicks/taps any location in the first region 701 and may directly trigger an operation manner of quick casting of a flash skill. A region between the first region 701 and an overall region 702 is a second region. As shown in (b) in FIG. 9, in the second region, the first user randomly clicks/taps any location in the second region, to trigger an aiming wheel. The first user may select, by using the aiming wheel, a casting direction of the flash skill, to trigger an operation manner of active aiming of the flash skill.

In some embodiments, the flash skill has two operation manners of quick casting and active aiming, and different operation manners of the flash skill determine different skill impact locations of the initiation skill.

FIG. 10 is a fourth flowchart of a game skill casting method according to an exemplary embodiment of this application.

Operation 310: Search a peripheral range for a virtual character when a casting operation on a flash skill conforms to an operation manner of quick casting.

In some embodiments, the quick casting is an operation manner in which a flash direction and/or a flash impact location of the flash skill are/is not selected. For example, the operation manner of quick casting is that the first user directly triggers casting of the flash skill without explicitly selecting a flash direction and a flash impact location for the player character.

In the operation manner of quick casting, the flash skill has two response manners of a first response manner and a second response manner. The first response manner is a response manner of automatically searching a peripheral range of a player character for a virtual character (when there is a virtual character of an enemy camp), and the second response manner is a response manner of moving by a fixed length in a flash direction (when there is no virtual character of the enemy camp). The flash direction in the second response manner may be a facing direction of the player character or a casting direction of an initiation skill.

For example, the first response manner is a response manner of automatically searching for an enemy virtual character and moving by a non-fixed length, and the second response manner is a response manner of not automatically searching for an enemy virtual character and moving by a fixed length.

The flash direction is a direction in which the first user controls the player character to flash, and the flash impact location is a specific location of the player character after the flashing.

In some embodiments, when the casting operation on the flash skill conforms to the operation manner of quick casting, a program module corresponding to the flash skill controls the flash skill to be in the first response manner, that is, searching the peripheral range for a virtual character. In this case, no additional specified direction and location is required. The program module corresponding to the flash skill searches the peripheral range of the player character for the virtual character and uses a location of the virtual character as a skill impact location of the initiation skill.

In an example, after the virtual character is found within the peripheral range of the player character, at least one of an attribute value, aura information, and a skill indicator from the player character to the virtual character of the virtual character within the peripheral range is displayed.

In some embodiments, a virtual character meeting a preset rule exists within the peripheral range of the player character (a virtual character closest to the player character exists within the peripheral range or a virtual character having a lowest attribute value exists within the peripheral range), and the virtual character meeting the preset rule is highlighted on the game interface.

In some embodiments, Attribute value: The attribute value is a value configured for quantizing various features of a virtual character in a game. These values reflect various abilities and states of the virtual character in the game, for example, a health point (HP), a magic point (MP), attack power, defense power, a speed, and a critical hit rate. After the virtual character is found within the peripheral range of the player character, a displayed attribute value may help a player learn strength and a battle capability of the virtual character, so that a corresponding battle policy is formulated.

In some embodiments, aura information: The aura information is information about a special effect or a gain state related to a virtual character in some games. These effects may include visual effects (for example, an aura and color change) around a character, and provided state effects (for example, increasing attack power, providing a shield, and reducing damage). The aura information is typically configured for indicating a current state of a character or an activated state of a special skill. A player may determine a threat level of an enemy character or take advantage of a vulnerability of the enemy character by using the information.

In some embodiments, skill indicator: The skill indicator is a graphic or visual element configured for representing a skill that the player character may use and an effect of the skill in a game. After the virtual character is found within the peripheral range of the player character, the skill indicator displays a skill casting path, a possible hit region, or an effect range between the player character and the virtual character. The skill indicator typically includes an arrow, a light beam, a circular region, and the like. The skill indicator provides direction and distance information needed when a player character performs a skill, helping the player accurately cast the skill.

For example, highlighting the virtual character includes displaying the attribute value of the virtual character, and the attribute value is configured for representing a current energy state of the virtual character. For example, the attribute value of the virtual character is highlighted in a form of a progress bar. Highlighting the virtual character includes displaying the aura information of the virtual character, for example, displaying the aura information of the virtual character as a light column effect, for highlighting a location and existence of the virtual character. Highlighting the virtual character includes displaying the skill indicator from the player character to the virtual character, and the skill indicator is configured for indicating at least one of a skill casting direction, a range, a distance, and the like from the player character to the virtual character.

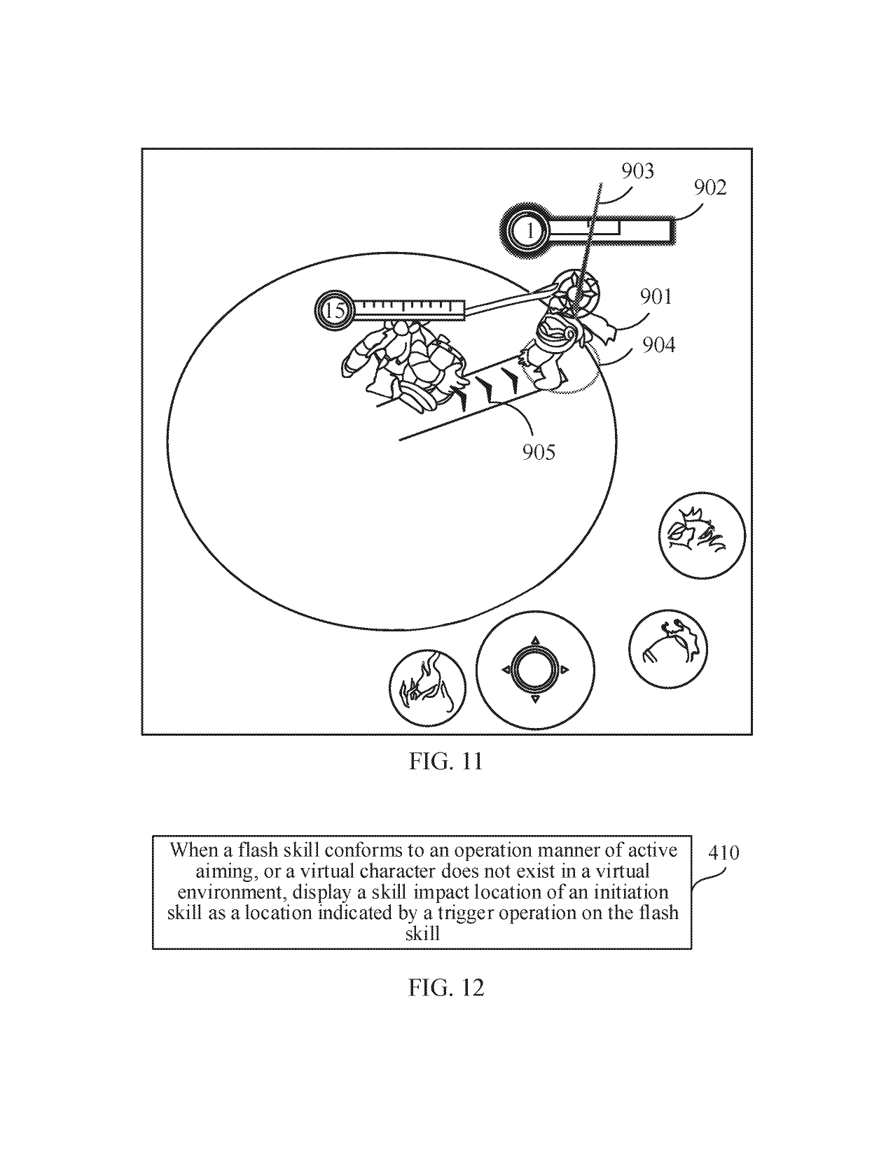

For example, as shown in FIG. 11, FIG. 11 is a sixth schematic diagram of a principle of a game skill casting method according to an exemplary embodiment of this application. A virtual character 901 meeting a preset rule exists within a peripheral range of a player character. The virtual character 901 and related information of the virtual character 901 are highlighted on a game interface, an attribute value 902 of the virtual character 901 is highlighted on the game interface, a light column 903 on the virtual character 901 and an aura 904 under the foot of the virtual character 901 are highlighted on the game interface, and a skill indicator 905 from the player character to the virtual character 901 is further displayed on the game interface. The virtual character 901 is displayed by using an intuitive visual effect, helping the first user notice a location and a state of the virtual character 901.

In this way, the attribute value, the aura information, and the skill indicator of the virtual character are highlighted, so that richer visual feedback is provided for a game, thereby enhancing immersion and game experience of the player. A progress bar of the attribute value is displayed, so that the player can quickly evaluate a fighting ability of an enemy, helping the player to make a rapid and accurate decision. A visual special effect of the aura information enables a player to identify a state of an enemy more easily, thereby improving a tactical execution capability in a battle. Use of the skill indicator reduces a player's guess about skill casting, and improves skill use accuracy and efficiency. The highlighted display effect improves a game skill and a battle policy of a player, and also increases playability and ornament of a game. In this manner, the player can understand and master a game mechanism more deeply, thereby achieving a better result in a game.

FIG. 12 is a fifth flowchart of a game skill casting method according to an exemplary embodiment of this application.

Operation 410: When a flash skill conforms to an operation manner of active aiming, or a virtual character does not exist in a virtual environment, display a skill impact location of an initiation skill as a location indicated by a trigger operation on a flash skill.

In some embodiments, the active aiming is an operation manner in which a flash direction and/or a flash impact location of the flash skill are/is selected. For example, the operation manner of active aiming is that a first user explicitly selects a flash direction and a flash impact location for a player character, to trigger casting of the flash skill.

In some embodiments, when an operation manner of the flash skill is active aiming, the first user may adjust a flash direction of the flash skill by using a flash skill control, where a casting distance of the flash skill is a fixed distance, and the skill impact location of the initiation skill of the player character is a location at which the first user controls casting of the flash skill by using the flash skill control.

In some embodiments, the operation manner of active aiming is an operation mechanism in which a player needs to manually control a skill casting direction and a target point in a game. In this operation manner, the player cannot cast a skill simply by clicking/tapping or pressing a key, but needs to precisely specify a skill casting direction and a target location by using an input device such as a joystick, a mouse, or a touchscreen. This manner typically requires the player to have a higher operating skill and reaction speed.

In some embodiments, the skill impact location is a location or a region on which a skill actually takes effect after being casted in a game. The location is a core point of a skill effect range and determines hitting and an effect of a skill.

In some embodiments, when the flash skill conforms to the operation manner of active aiming, or no virtual character exists in a peripheral range, the skill impact location of the initiation skill is displayed as the location indicated by the trigger operation on the flash skill, which is a mechanism in a game. A target location of the initiation skill is not determined based on a location of an enemy virtual character but is determined based on a direction or a location specified by a player when a flash skill is triggered. This mechanism allows the player to still execute a skill without any enemy character, or freely select an impact point of skill casting when using a flash skill that requires accurate aiming.

In some embodiments, there may be no virtual character within the peripheral range. When the operation manner of the flash skill is quick casting, and no virtual character exists within the peripheral range, a flash direction for the player character is a direction supported by a movement joystick, or a facing direction of the player character when receiving a casting operation on the flash skill, or a casting direction of the initiation skill of the player character (the initiation skill is a directional skill). The skill impact location of the initiation skill of the player character is a location at which the first user controls casting of the flash skill by using the flash skill control.

The trigger operation on the flash skill is a trigger operation performed by the first user on a flash skill control. For example, a virtual key is displayed on a touchscreen. The trigger operation is at least one of operations such as a single-tap operation, a double-tap operation, a long press operation, and a swipe operation performed on the virtual key. Alternatively, the trigger operation on the flash skill is an operation of pressing a specified button on a physical handle or a keyboard. This is not limited in this application.

Based on the foregoing, according to the method provided in this embodiment of this application, the flash skill has two operation manners of quick casting and active aiming. Different operation manners of the flash skill determine different skill impact locations of the initiation skill. When the casting operation on the flash skill conforms to the operation manner of quick casting, the virtual character is found within the peripheral range, and if the virtual character exists within the peripheral range, the virtual character is highlighted, and the skill impact location of the initiation skill of the player character is the location of the virtual character. When the flash skill conforms to the operation manner of active aiming, or no virtual character exists within the peripheral range, the skill impact location of the initiation skill of the player character is the location indicated by the trigger operation on the flash skill.

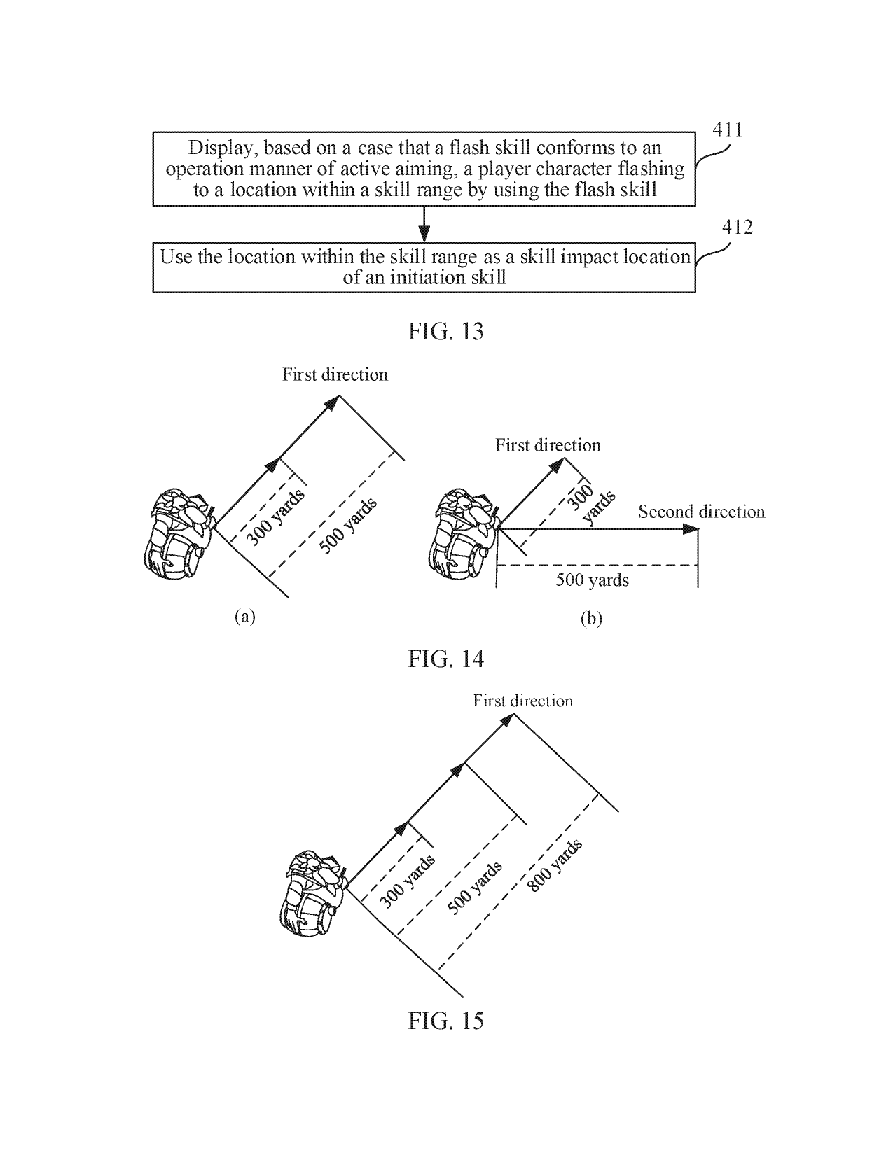

In some embodiments, when the flash skill conforms to the operation manner of active aiming, the skill impact location of the initiation skill is the location indicated by the trigger operation on the flash skill. As shown in FIG. 13, FIG. 13 is a sixth flowchart of a game skill casting method according to an exemplary embodiment of this application. Operation 410 may be replaced with the following sub-operation.

Operation 411: Display, based on a case that a flash skill conforms to an operation manner of active aiming, a player character flashing to a location within a skill range by using the flash skill.

The skill range is at least one of a fixed range length of the flash skill, a default movement length of the initiation skill, a first sum, a second sum, or a third sum.

In some embodiments, the skill range of the flash skill is that the player character instantaneously moves to a location with a fixed distance by using the flash skill. When the first user uses the operation manner of active aiming of the flash skill, the player character may be transferred to a location within a preset fixed distance range. A length between the location and a location of the player character before the flashing is a fixed range length, and the fixed range length determines a farthest distance to which the player character can move.

In some embodiments, when the initiation skill is a directional movement skill, a default movement length of the initiation skill is a preset movement length. The first sum is a sum of the fixed range length of the flash skill and the default movement length of the initiation skill, the second sum is a sum of the fixed range length of the flash skill and a first projection movement length of the initiation skill, and the third sum is a sum of the fixed range length of the flash skill and a second projection movement length of the initiation skill. The first projection movement length is a remaining movement length of the initiation skill in the first direction, the second projection movement length is a length of the remaining movement length projected in the casting direction of the flash skill, and the remaining movement length is a difference between the default movement length of the initiation skill and a distance length of the initiation skill casted in the first direction.

In some embodiments, the skill range of the flash skill is configured for a tactical operation of rapid movement of the player character, allowing the player character to change a location in short time to rapidly approach the virtual character and attack the virtual character. When the operation manner of the flash skill is active aiming, the skill impact location of the initiation skill of the player character is determined according to the skill range of the flash skill, representing a farthest distance to which the player character can flash.

In some embodiments, the initiation skill is a directional movement skill, the initiation skill has a default movement length, and the flash skill is used by the first user to control the player character to instantaneously move a fixed range length.

In a possible implementation, the skill range of the player character is the fixed range length of the flash skill. After the first user triggers casting of the initiation skill, at the beginning of an action or an effect of the initiation skill, the first user triggers casting of the flash skill. In this case, the fixed range length of the flash skill covers the default movement length of the initiation skill, that is, the skill range of the player character is the fixed range length of the flash skill.

For example, as shown in FIG. 14, FIG. 14 is a seventh schematic diagram of a principle of a game skill casting method according to an exemplary embodiment of this application. A default movement length of an initiation skill is 300 yards. When a flash skill conforms to an operation manner of active aiming, a fixed range length of the flash skill is 500 yards. The first user triggers casting of the initiation skill. At the beginning of an action or an effect of the initiation skill, the first user triggers casting of the flash skill (a time interval between triggering the initiation skill and triggering the flash skill by the first user is short by default). As shown in (a) in FIG. 14, when both casting directions of the initiation skill and the flash skill are a first direction, that is, the directions are the same, a skill range of a player character is 500 yards. As shown in (a) in FIG. 14, when the casting direction of the initiation skill is the first direction, and the casting direction of the flash skill is a second direction, that is, directions of the initiation skill and the flash skill are different, the skill range of the player character is 500 yards, that is, a movement distance of the initiation skill of the player character is 500 yards.

In a possible implementation, the skill range of the player character is a first sum, that is, the movement distance of the initiation skill of the player character is a sum of the fixed range length of the flash skill and the default movement length of the initiation skill. After the first user triggers casting of the initiation skill, at the beginning of an action or an effect of the initiation skill, the first user triggers casting of the flash skill. When the casting directions of the initiation skill and the flash skill are the same, the movement distance of the initiation skill of the player character is a sum of the default movement length of the initiation skill and the fixed range length of the flash skill.

For example, as shown in FIG. 15, FIG. 15 is an eighth schematic diagram of a principle of a game skill casting method according to an exemplary embodiment of this application. A default movement length of an initiation skill is 300 yards. When a flash skill conforms to an operation manner of active aiming, a fixed range length of the flash skill is 500 yards. The first user triggers casting of the initiation skill. At the beginning of an action or an effect of the initiation skill, the first user triggers casting of the flash skill (a time interval between triggering the initiation skill and triggering the flash skill by the first user is short by default). When both casting directions of the initiation skill and the flash skill are a first direction, that is, the directions are the same, a skill range of a player character is a sum of the default movement length of the initiation skill and the fixed range length of the flash skill, that is, a skill range of a player character is 800 yards, that is, a movement distance of the initiation skill of the player character is 800 yards.

In a possible implementation, the skill range of the player character is a second sum, that is, the movement distance of the initiation skill of the player character is a sum of a fixed range length of the flash skill and a first projection movement length of the initiation skill. The first projection movement length is a remaining movement length of the initiation skill in the first direction, and the remaining movement length is a difference between the default movement length of the initiation skill and a distance length of the initiation skill casted in the first direction. After the first user triggers casting of the initiation skill, at the beginning of an action or an effect of the initiation skill, the first user triggers casting of the flash skill. In this case, the initiation skill has been casted in the first direction for a specific distance. When the casting directions of the initiation skill and the flash skill are different, the movement distance of the initiation skill of the player character is a sum of the fixed range length of the flash skill and the remaining movement length of the initiation skill in the first direction, and the remaining movement length is a difference between the default movement length of the initiation skill and the distance length of the initiation skill casted in the first direction.

In some embodiments, the skill range is a maximum distance range on which a skill can act in a game. Within this range, the skill may produce an expected effect on a target. The skill range may be fixed, or may vary according to a skill level, an attribute of a player character, or another factor.

In some embodiments, the first sum is a value obtained by adding the fixed range length of the flash skill and the default movement length of the initiation skill. The value determines a total distance that the player character can reach after casting the flash skill and to which the default movement length of the initiation skill is added.

In some embodiments, the second sum is a value obtained by adding the fixed range length of the flash skill and the first projection movement length of the initiation skill. The first projection movement length is a remaining movement length of the initiation skill in the first direction, and the value determines a total distance that can be reached by using the initiation skill in the first direction after considering the flash skill.

In this way, based on a skill casting mechanism of the operation manner of active aiming, a player character flashes to a location within a skill range by using a flash skill in a game, and the location is used as a skill impact location of an initiation skill, greatly enriching tactical options and fight flexibility of the player. When the skill range of the player character is set to the second sum, that is, the sum of the fixed range length of the flash skill and the first projection movement length of the initiation skill, the player can accurately control an impact point and a movement distance of a skill. Calculation of the first projection movement length considers a difference between the default movement length and an actual casting distance of the initiation skill, so that the player can adjust a movement path of the skill according to an actual situation when casting the initiation skill. When the casting directions of the initiation skill and the flash skill are different, a player may implement a more complex tactical action in this manner, for example, launching an attack in a direction first, and then rapidly flashing to another direction. Such an operation not only increases dynamism and tactful of a game, but also improves a reaction speed and operation accuracy of the player in a battle. In addition, this mechanism allows a player to immediately trigger the flash skill after casting the initiation skill, to implement a continuous skill combination, so that the player can deal with battle field changes more effectively, thereby improving competitiveness and fun of a game. In general, such a skill casting mechanism provides brand new game experience for a player, and enhances control of the player over a battle rhythm, so that a game play method is more deeply and diversified.

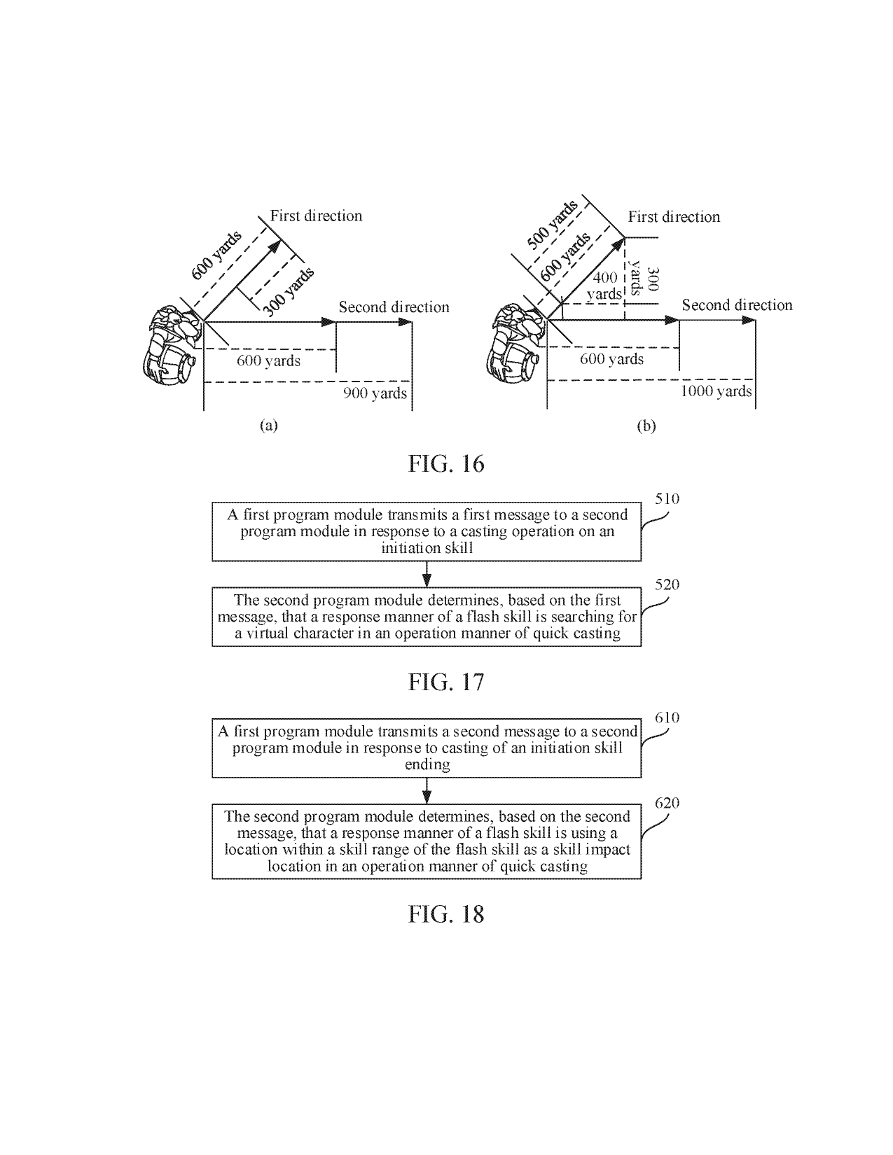

For example, as shown in FIG. 16, FIG. 16 is a ninth schematic diagram of a principle of a game skill casting method according to an exemplary embodiment of this application. A default movement length of an initiation skill is 600 yards. When a flash skill conforms to an operation manner of active aiming, a fixed range length of the flash skill is 600 yards. A first user triggers casting of the initiation skill, and when an action or an effect of the initiation skill has not ended, the first user triggers casting of the flash skill. As shown in (a) in FIG. 16, when casting directions of the initiation skill and the flash skill are different, a skill range of a player character is a sum of the fixed range length of the flash skill and a remaining movement length of the initiation skill in a first direction, where the remaining movement length is 300 yards, so that the skill range of the player character is 900 yards, that is, a movement distance of the initiation skill of the player character is 900 yards.

In a possible implementation, the skill range of the player character is a third sum, that is, the movement distance of the initiation skill of the player character is a sum of the fixed range length of the flash skill and a second projection movement length of the initiation skill, where the second projection movement length is a length of the remaining movement length projected in the casting direction of the flash skill. After the first user triggers casting of the initiation skill, when an action or an effect of the initiation skill has not ended, the first user triggers casting of the flash skill. In this case, the initiation skill has been casted in the first direction for a specific distance. When the casting directions of the initiation skill and the flash skill are different, the movement distance of the initiation skill of the player character is a sum of the fixed range length of the flash skill and the length of the remaining movement length of the initiation skill in the first direction projected in the casting direction of the flash skill, and the remaining movement length is a difference between the default movement length of the initiation skill and the distance length of the initiation skill casted in the first direction.

In some embodiments, the third sum is a value obtained by adding the fixed range length of the flash skill and the second projection movement length of the initiation skill. The second projection movement length is a length of the remaining movement length projected in the casting direction of the flash skill, and the value determines a total distance that can be reached by using the initiation skill in a flash direction after the flash skill is considered.

For example, as shown in FIG. 16, the default movement length of the initiation skill is 600 yards. When the flash skill conforms to the operation manner of active aiming, the fixed range length of the flash skill is 600 yards. After first user triggers casting of the initiation skill, when an action or an effect of the initiation skill has not ended, the first user triggers casting of the flash skill. As shown in (b) in FIG. 16, when the casting directions of the initiation skill and the flash skill are different, the skill range of the player character is a sum of the fixed range length of the flash skill and a length of the remaining movement length projected in a second direction, where the remaining movement length of the initiation skill is 500 yards, and the length of the remaining movement length projected in the casting direction of the flash skill is 400 yards. In this case, the skill range of the player character is 1000 yards (the sum of the fixed range length of the flash skill and the length of the remaining movement length of the initiation skill projected in the second direction), that is, the movement distance of the initiation skill of the player character is 1000 yards.

In this way, based on the flash skill of the operation manner of active aiming, the player character flashing to the location within the skill range is displayed, and the location is used as the skill impact location of the initiation skill, to provide great tactical freedom and accuracy for the player. When the skill range is defined as the third sum, that is, the sum of the fixed range length of the flash skill and the second projection movement length of the initiation skill, the player can more flexibly plan a combo of a skill and tactical execution. The player may select an appropriate combination of the initiation skill and the flash skill according to a battle requirement. By adjusting a casting direction of the flash skill and a movement length of the initiation skill, the player may implement diversified attack policies, for example, bypassing an obstacle, avoiding an enemy attack, or violating an enemy vulnerability. Impact points of the flash skill and the initiation skill can be accurately controlled, to implement a rapid and smooth skill combo. The combo capability is especially important against fast-moving or high-defense enemies. The first projection movement length and the second projection movement length are calculated, so that the player can more effectively use the default movement length of the initiation skill. Such optimization can reduce unnecessary movement, make skill use more efficiently, and save precious skill resources. The player may accurately predict and position a skill impact location according to the fixed range length of the flash skill and the second projection movement length of the initiation skill. Such accuracy is crucial for performing complex tactics and fighting difficult enemies. After a complex skill combination is successfully executed, satisfaction and a feeling of accomplishment are obtained. This game design increases immersion of a player on the game, and improves overall satisfaction of the player. A skill casting mechanism based on the operation manner of active aiming not only enhances tactful and an operation capability of a player in combat, but also improves overall playability of a game and game experience of the player.

Operation 412: Use the location within the skill range as the skill impact location of the initiation skill.

In some embodiments, when an operation manner of the flash skill is active aiming, the skill impact location of the initiation skill of the player character corresponds to the location within the skill range of the flash skill, and the player character directly casts the initiation skill to the location within the skill range of the flash skill.

In some embodiments, when the first user controls the player character to continuously cast a plurality of skill combinations to form a combo, a skill impact location may be considered as a skill impact location of an initiation skill; or considered as a skill impact location of a flash skill; or considered as a skill impact location of the combo.

In this application, an example in which the skill impact location is the skill impact location of the initiation skill is used for description.

Based on the foregoing, according to the method provided in this embodiment of this application, based on a case that a flash skill conforms to an operation manner of active aiming, a player character flashing to a location within a skill range by using the flash skill is displayed, and the location within the skill range is used as a skill impact location of an initiation skill. The first user may control a casting direction of the flash skill, to control a direction of the skill impact location of the initiation skill.

In response to casting of the initiation skill

In some embodiments, the initiation skill is added to a listening list, when the initiation skill starts to be casted, a program module corresponding to the initiation skill transmits a message to a program module corresponding to the flash skill, to notify a state of the initiation skill.

FIG. 17 is a seventh flowchart of a game skill casting method according to an exemplary embodiment of this application.

Operation 510: A first program module transmits a first message to a second program module in response to a casting operation on an initiation skill.

The first message is configured for notifying that the initiation skill is casted.

In some embodiments, the initiation skill is implemented by the first program module, and a flash skill is implemented by the second program module.

In some embodiments, the first program module and the second program module are two different program modules or components. The first program module and the second program module are respectively responsible for implementing the initiation skill and the flash skill. The first program module is a program module responsible for implementing the initiation skill. The first program module includes logic and an effect of the initiation skill, and a related game rule. When the first user performs the casting operation on the initiation skill, the first program module is responsible for processing the casting operation, and the first program module transmits, to the second program module, a notification message indicating that the initiation skill is casted. The second program module is a program module responsible for implementing the flash skill, and the second program module includes logic and an effect of the flash skill, and a related game rule. When the first program module transmits, to the second program module, the notification message indicating that the initiation skill is casted, the second program module determines a response manner of the flash skill according to the notification message. For example, the second program module determines an operation manner in which the first user casts the flash skill, where the first user casts the flash skill in two operation manners of quick casting and active aiming.

In some embodiments, the initiation skill is added to a listening list, and the listening list is a data structure and configured for storing the initiation skill. In some embodiments, the listening list may be at least one of data structures such as an array, a list, and a queue. Related information (for example, an identifier and casting time of the initiation skill) of the initiation skill is added to the listening list as an object or a data item. A state of the initiation skill in the listening list is updated in a casting process of the initiation skill. If the initiation skill is in a casting state, that is, the first user triggers casting of the initiation skill, the first program module corresponding to the initiation skill transmits the first message to the second program module corresponding to the flash skill, where the first message is configured for notifying that the initiation skill is casted.

In this way, logic of the initiation skill and logic of the flash skill are respectively encapsulated in the first program module and the second program module, so that a modularized design of a game system is enhanced. Such modularization not only facilitates maintenance and expansion of code, but also improves stability and testability of the system. After detecting the casting operation on the initiation skill, the first program module immediately transmits the notification message to the second program module, to ensure that the flash skill can quickly respond to casting of the initiation skill. Such an instant message transfer mechanism improves a response speed of an operation of a player, and enhances game experience of the player. The second program module determines the response manner of the flash skill according to the received notification message. This enables the player to flexibly select the operation manner of quick casting or active aiming according to a battle situation. This flexibility allows the player to achieve a more complex combination of tactics and skills in a battle. Cast processing of the initiation skill and response logic of the flash skill are separated, thereby simplifying logic processing inside each module. The first program module focuses on casting logic of the initiation skill, and the second program module focuses on response logic of the flash skill. Such division of labor makes functions of the modules clearer and more focused. A message transfer mechanism between modules provides a basis for future extension of game functions. If new skills or functions need to be added to a game, a developer can integrate new logic more easily without affecting an existing module.

Operation 520: The second program module determines, based on the first message, that a response manner of the flash skill is searching for the virtual character in an operation manner of quick casting.

The second program module is a program module corresponding to the flash skill.

In some embodiments, when the first program module transmits the first message to the second program module, the second program module receives the first message and performs a corresponding response according to content of the first message.

In a possible implementation, after the first message is transmitted by the first program module, the second program module listens to a message queue or an event of the first message, receives the first message, and performs a response after receiving the first message.

In some embodiments, when the first user triggers the flash skill, the second program module determines the response manner of the flash skill according to the first message. In some embodiments, when the operation manner in which the first user casts the flash skill is quick casting, the program module corresponding to the flash skill controls the response manner of the flash skill to be a response manner of automatically searching a peripheral range of a player character for a virtual character (when there is a virtual character of an enemy camp), and the program module corresponding to the flash skill controls the player character to search the peripheral range for the virtual character, and controls a location of the found virtual character to be used as a skill impact location of an initiation skill of the player character, that is, a skill impact location of the flash skill.

Based on the foregoing, according to the method provided in this embodiment of this application, the first program module implements an initiation skill, and the second program module implements a flash skill, so that logic processing and a response can be independently performed on the initiation skill and the flash skill. The first program module corresponding to the initiation skill transmits, to the second program module corresponding to the flash skill, a message indicating that the initiation skill is casted, and the second program module corresponding to the flash skill performs a corresponding response. Through interaction and cooperation between the two program modules, interaction between the initiation skill and the flash skill is implemented.

In response to casting of the initiation skill ending

In some embodiments, when casting of the initiation skill ends, the program module corresponding to the initiation skill transmits a message to the program module corresponding to the flash skill, to notify a state of the initiation skill.

FIG. 18 is an eighth flowchart of a game skill casting method according to an exemplary embodiment of this application.

Operation 610: A first program module transmits a second message to a second program module in response to casting of an initiation skill ending.

The second message is configured for notifying that casting of the initiation skill ends.

The initiation skill is implemented by the first program module, and a flash skill is implemented by the second program module.

In some embodiments, that casting of the initiation skill ends indicates that a casting process of the initiation skill has been completed, and a related effect of the initiation skill has taken effect. When casting of the initiation skill ends, the first program module transmits the second message to the second program module, where the second message is configured for notifying the second program module that casting of the initiation skill has ended.

In some embodiments, content of the second message includes some information about ending of casting of the initiation skill, for example, an identifier of the initiation skill, a casting result, or other related data. The second message may be transmitted by using a message queue, an event system, or another communication mechanism. After receiving the second message, the second program module performs a corresponding response according to the second message. For example, the second program module changes a skill impact location of the flash skill.

Operation 620: The second program module determines, based on the second message, that a response manner of the flash skill is using a location within a skill range of the flash skill as a skill impact location in an operation manner of quick casting.

The second program module is a program module corresponding to the flash skill. The second message is configured for notifying that casting of the initiation skill ends.

In some embodiments, when the first program module transmits the second message to the second program module, the second program module receives the second message and performs a corresponding response according to content of the second message.

In a possible implementation, after the second message is transmitted by the first program module, the second program module listens to a message queue or an event of the second message, receives the second message, and performs a response after receiving the second message.

In some embodiments, when the first user triggers the flash skill, the second program module determines the response manner of the flash skill according to the second message. In some embodiments, when the operation manner in which the first user casts the flash skill is quick casting, the program module corresponding to the flash skill controls a response manner of the flash skill to be restored from a response manner of automatically searching a peripheral range of a player character for a virtual character (when there is a virtual character of an enemy camp) to a response manner of moving by a fixed length in a flash direction (when there is no virtual character of an enemy camp), that is, the second program module controls a location within a skill range of the flash skill to be used as a skill impact location. In this case, the skill impact location of the player character is a location indicated by a fixed range length rather than a location of the virtual character within the peripheral range.

In this way, the second message is transmitted, the game system provides clear operation state feedback to a player. The player may learn that the initiation skill has been successfully casted, and the system has prepared to respond to a subsequent flash skill operation. This increases a feeling of the player about game control. The second program module determines the response manner of the flash skill based on the second message, to ensure precise coordination between the initiation skill and the flash skill. Such coordination avoids a conflict or delay between skill casting, so that the skill combination is smoother and more effective. In the operation manner of quick casting, the location within the skill range of the flash skill is directly used as the skill impact location, to simplify operation logic of the player. The player does not need to perform additional aiming or adjustment, and only needs to quickly cast the flash skill. This reduces operation complexity and improves skill use efficiency. The player is allowed to respond to a battle situation more rapidly, and adjust a location of the player or avoid an attack of an enemy by quickly casting a flash skill, thereby better controlling a battle rhythm. When executing a skill combination, the player can feel a seamless connection between skills and an instant feedback. This improves game experience of the player, and makes the player feel more immersive in a game world. In the operation manner of quick casting, the player may quickly use the flash skill according to a battle requirement. This flexibility allows the player to adopt a more flexible and diversified policy according to different battle scenarios and enemy behaviors.

Based on the foregoing, according to the method provided in this embodiment of this application, the first program module implements an initiation skill, and the second program module implements a flash skill, so that logic processing and a response can be independently performed on the initiation skill and the flash skill. The first program module corresponding to the initiation skill transmits, to the second program module corresponding to the flash skill, a message indicating that casting of the initiation skill ends, and the second program module corresponding to the flash skill performs a corresponding response. Through interaction and cooperation between the two program modules, interaction between the initiation skill and the flash skill is implemented.

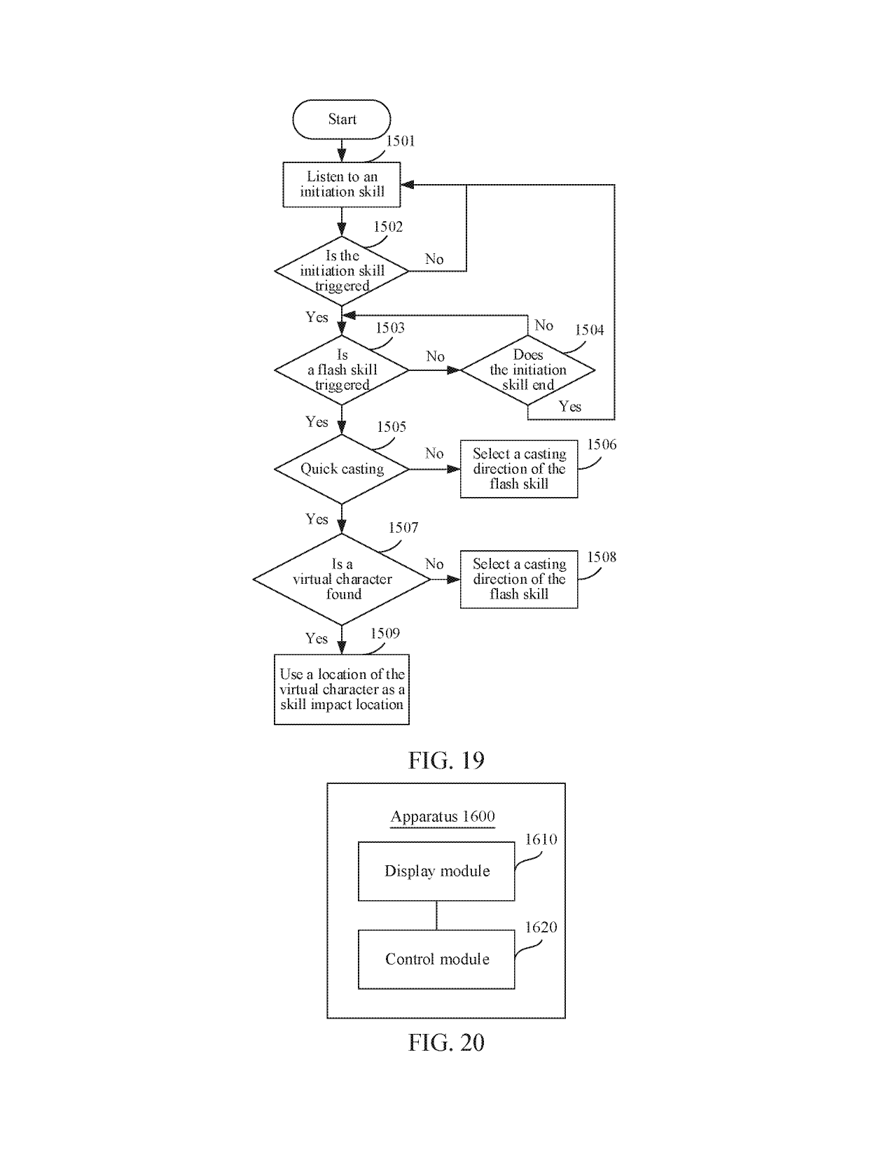

FIG. 19 is a ninth flowchart of a game skill casting method according to an exemplary embodiment of this application. The method may be performed by a client on a terminal device in the system shown in FIG. 1. The method includes the following operations.

Operation 1501: Listen to an initiation skill.

In some embodiments, the initiation skill is added to a listening list, and the initiation skill in the listening list is listened to.

Operation 1502: Determine whether the initiation skill is triggered.

It is determined whether the initiation skill in the listening list is triggered. If the initiation skill in the listening list is triggered, a program module corresponding to the initiation skill transmits, to a program module corresponding to a flash skill, a message indicating that the initiation skill is casted.

If the initiation skill in the listening list is not triggered, the initiation skill in the listening list continues to be listened to.

Operation 1503: When the initiation skill is triggered, determine whether a flash skill is triggered.

When the initiation skill is triggered, it is determined whether the first user triggers the flash skill.

Operation 1504: When the flash skill is triggered, determined whether casting of the initiation skill ends.

When the first user triggers the flash skill, it is determined, depending on a case whether an action or an effect of the initiation skill ends, whether casting of the initiation skill ends,

Operation 1505: When the flash skill is triggered and the initiation skill has not ended, determine an operation manner of the flash skill.

The first user triggers the flash skill, and when the initiation skill is casted and an action or an effect of the initiation skill has not ended, the operation manner of the flash skill is determined, where the flash skill has two operation manners of quick casting and active aiming.

Operation 1506: When the operation manner of the flash skill is not quick casting, select a casting direction of the flash skill.

When the flash skill is in the operation manner of active aiming, the casting direction of the flash skill is selected. In this case, a skill impact location of the initiation skill is a location indicate by a trigger operation on the flash skill.

Operation 1507: Search a peripheral range for a virtual character when the operation manner of the flash skill is quick casting.

When the operation manner of the flash skill is quick casting, the program module corresponding to the flash skill controls a response manner of the flash skill to be automatically searching a peripheral range of a player character for a virtual character.

Operation 1508: When there is no virtual character within the peripheral range, select the casting direction of the flash skill.

When there is no virtual character within the peripheral range, the casting direction of the flash skill is selected. In this case, the skill impact location of the initiation skill is the location indicated by the trigger operation on the flash skill.

Operation 1509: When there is a virtual character within the peripheral range, use a location of the virtual character as a skill impact location.

When there is a virtual character within the peripheral range, the skill impact location of the initiation skill is the location of the virtual character.

FIG. 20 is a structural block diagram of a game skill casting apparatus according to an exemplary embodiment of this application. The apparatus has a function of implementing the above game skill casting method example, and the function may be implemented by hardware or by hardware executing corresponding software. The apparatus may be the foregoing described server, or may be disposed in the server. As shown in FIG. 20, the apparatus 1600 may include: a display module 1610 and a control module 1620.

The display module 1610 is configured to display a player character located in a virtual environment.

The control module 1620 is configured to control, in response to a casting operation on an initiation skill, the player character to cast the initiation skill.

The control module 1620 is configured to control, in response to receiving a casting operation on a flash skill in a casting process of the initiation skill, the player character to cast the flash skill.

The display module 1610 is configured to display, in response to a virtual character existing in a peripheral range of the player character in a casting process of the flash skill, at least one of a skill impact location of the initiation skill and a skill impact location of the flash skill as a location of the virtual character.

In some embodiments, the initiation skill is a directional skill; and the display module 1610 is configured to display, in response to a casting direction of the initiation skill being a first direction and the virtual character existing in a second direction in the peripheral range of the player character in the casting process of the flash skill, at least one of the skill impact location of the initiation skill and the skill impact location of the flash skill as the location of the virtual character.

The first direction and the second direction are different directions.

In some embodiments, the initiation skill is a directional movement skill, and the directional movement skill has a default movement length; and the display module 1610 is configured to display, in response to a casting direction of the initiation skill being a first direction and the virtual character existing in a second direction in the peripheral range of the player character in the casting process of the flash skill, at least one of a movement impact location of the initiation skill and the skill impact location of the flash skill as the location of the virtual character.

The first direction and the second direction are different directions, and a movement distance corresponding to the movement impact location is different from the default movement length.

In some embodiments, the virtual character is an enemy virtual character closest to the player character within the peripheral range.

In some embodiments, the virtual character is an enemy virtual character having a lowest attribute value within the peripheral range.

In some embodiments, the apparatus 1600 further includes a searching module.

In some embodiments, the searching module is configured to search the peripheral range for the virtual character when the casting operation on the flash skill conforms to an operation manner of quick casting.

The quick casting is an operation manner in which a flash direction and/or a flash impact location of the flash skill are/is not selected.

In some embodiments, the display module 1610 is configured to display at least one of an attribute value, aura information, and a skill indicator from the player character to the virtual character of the virtual character within the peripheral range.

In some embodiments, the display module 1610 is configured to: when the flash skill conforms to an operation manner of active aiming, or the virtual character does not exist within the peripheral range, display the skill impact location of the initiation skill as a location indicated by a trigger operation on the flash skill.

The active aiming is an operation manner in which the flash direction and/or the flash impact location of the flash skill are/is selected.

In some embodiments, the display module 1610 is configured to display, based on a case that the flash skill conforms to the operation manner of active aiming, the player character flashing to a location within a skill range by using the flash skill; and

use the location within the skill range as the skill impact location of the initiation skill.

In some embodiments, the skill range is at least one of a fixed range length of the flash skill, the default movement length of the initiation skill, a first sum, a second sum, or a third sum, the first sum is a sum of the fixed range length of the flash skill and the default movement length of the initiation skill, the second sum is a sum of the fixed range length of the flash skill and a first projection movement length of the initiation skill, the third sum is a sum of the fixed range length of the flash skill and a second projection movement length of the initiation skill, the first projection movement length is a remaining movement length of the initiation skill in the first direction, and the second projection movement length is a length of the remaining movement length projected in a casting direction of the flash skill; and the remaining movement length is a difference between the default movement length of the initiation skill and a distance length for which the initiation skill is casted in the first direction.

In some embodiments, the apparatus 1600 further includes a transmitting module.

In some embodiments, the transmitting module is configured to transmit, by a first program module, a first message to a second program module in response to the casting operation on the initiation skill, where the first message is configured for notifying that the initiation skill is casted.

In some embodiments, the searching module is configured to determine, by the second program module based on the first message, that a response manner of the flash skill is searching for the virtual character in the operation manner of quick casting.

In some embodiments, the transmitting module is configured to transmit, by the first program module, a second message to the second program module in response to casting of the initiation skill ending, where the second message is configured for notifying casting of the initiation skill ends.

In some embodiments, the apparatus 1600 further includes a determining module.

In some embodiments, the determining module is configured to determine, by the second program module based on the second message, that a response manner of the flash skill is using the location within the skill range of the flash skill as the skill impact location in the operation manner of quick casting.

For a specific limitation on the one or more game skill casting apparatus embodiments, refer to the limitation on the foregoing game skill casting method. Details are not described herein again. The modules in the foregoing apparatus may be implemented entirely or partially by software, hardware, or a combination thereof. The foregoing modules may be built in or independent of a processor of a computer device in a hardware form, or may be stored in a memory of the computer device in a software form, so that the processor invokes and performs an operation corresponding to each of the foregoing modules.

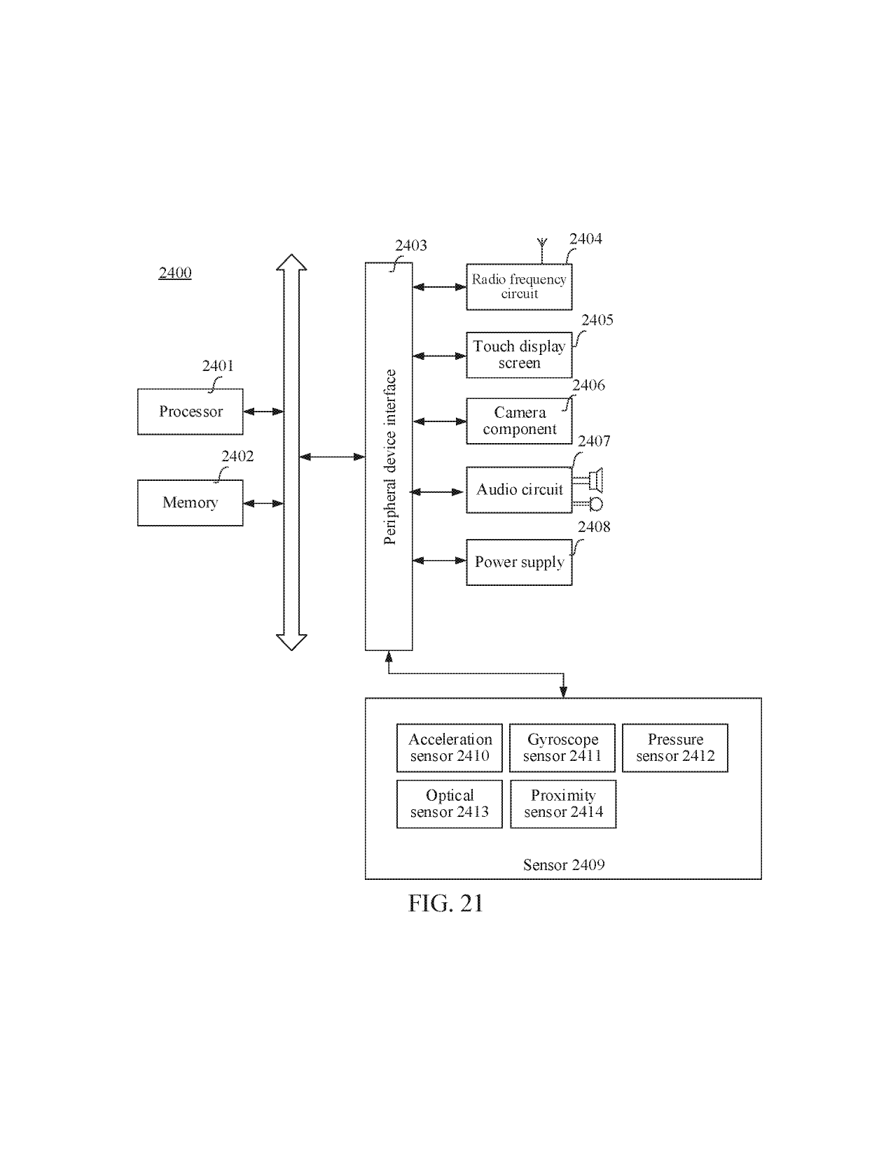

FIG. 21 is a structural block diagram of a computer device 2400 according to an exemplary embodiment of this application. The computer device 2400 may be a portable mobile terminal, such as a smartphone, a tablet computer, an MP3 player, or an MP4 player. The computer device 2400 may be further referred to as another name such as user equipment or a portable terminal.

Generally, the computer device 2400 includes a processor 2401 and a memory 2402.

The processor 2401 may include one or more processing cores, and may be, for example, a 4-core processor or an 8-core processor. The processor 2401 may be implemented by using at least one hardware form of a digital signal processor (DSP), a field programmable gate array (FPGA), and a programmable logic array (PLA). The processor 2401 may alternatively include a main processor and a coprocessor. The main processor is configured to process data in an active state, also referred to as a central processing unit (CPU). The coprocessor is a low-power processor configured to process data in a standby state. In some embodiments, the processor 2401 may be integrated with a graphics processing unit (GPU). The GPU is configured to render and draw content that needs to be displayed on a display screen. In some embodiments, the processor 2401 may further include an AI processor. The AI processor is configured to process computing operations related to machine learning.

The memory 2402 may include one or more computer-readable storage media. The computer-readable storage medium may be tangible and non-transient. The memory 2402 may further include a high-speed random access memory (RAM), and a non-volatile memory such as one or more magnetic disk storage devices and a flash storage device. In some embodiments, a non-transitory computer-readable storage medium in the memory 2402 is configured to store at least one instruction, the at least one instruction being configured to be executed by the processor 2401 to implement the game skill casting method provided in the embodiments of this application.

In some embodiments, the computer device 2400 further exemplarily includes a peripheral device interface 2403 and at least one peripheral device. Specifically, the peripheral device includes: at least one of a radio frequency circuit 2404, a touch display screen 2405, a camera 2406, an audio circuit 2407, and a power supply 2408.

The peripheral device interface 2403 may be configured to connect at least one peripheral device related to input/output (I/O) to the processor 2401 and the memory 2402. In some embodiments, the processor 2401, the memory 2402, and the peripheral device interface 2403 are integrated on the same chip or the same circuit board. In some other embodiments, any or both of the processor 2401, the memory 2402, and the peripheral device interface 2403 may be implemented on an independent chip or circuit board, which is not limited in this embodiment.

The radio frequency circuit 2404 is configured to receive and transmit a radio frequency (RF) signal, which is also referred to as an electromagnetic signal. The radio frequency circuit 2404 communicates with a communication network and another communication device by using the electromagnetic signal. The radio frequency circuit 2404 converts an electrical signal into an electromagnetic signal for transmission, or converts a received electromagnetic signal into an electrical signal. The radio frequency circuit 2404 includes: an antenna system, an RF transceiver, one or more amplifiers, a tuner, an oscillator, a digital signal processor, a codec chip set, a subscriber identity module card, and the like. The radio frequency circuit 2404 may communicate with another terminal by using at least one wireless communication protocol. The wireless communication protocol includes, but is not limited to: a world wide web, a metropolitan area network, an intranet, generations of mobile communication networks (2G, 3G, 4G, and 5G), a wireless local area network, and/or a wireless fidelity (Wi-Fi) network. In some embodiments, the radio frequency circuit 2404 may further include a circuit related to near field communication (NFC), which is not limited in this application.

The touch display screen 2405 is configured to display a user interface (UI). The UI may include a graph, a text, an icon, a video, and any combination thereof. The touch display screen 2405 also has a capability of collecting a touch signal on or above a surface of the touch display screen 2405. The touch signal may be inputted, as a control signal, to the processor 2401 for processing. The touch display screen 2405 is configured to provide a virtual button and/or a virtual keyboard, which is also referred to as a soft button and/or a soft keyboard. In some embodiments, there may be one display screen 2405, disposed on a front panel of the computer device 2400. In other some embodiments, there may be at least two display screens 2405, disposed on different surfaces of the computer device 2400 respectively or in a folded design. In some embodiments, the touch display screen 2405 may be a flexible display screen, disposed on a curved surface or a folded surface of the computer device 2400. Even, the touch display screen 2405 may be further set in a non-rectangular irregular pattern, namely, a special-shaped screen. The touch display screen 2405 may be made of a material such as a liquid crystal display (LCD) or an organic light-emitting diode (OLED).

The camera 2406 is configured to collect an image or a video. The camera 2406 includes a front-facing camera and a rear-facing camera. Generally, the front-facing camera is configured to implement a video call or self-portrait. The rear-facing camera is configured to capture a picture or a video. In some embodiments, there are at least two rear-facing cameras, each of which is any one of a main camera, a depth of field camera and a wide-angle camera, to implement a background blurring function by fusing the main camera and the depth of field camera, and panoramic shooting and virtual reality (VR) shooting functions by fusing the main camera and the wide-angle camera. In some embodiments, the camera 2406 may further include a flash. The flash may be a single-color-temperature flash, or may be a double-color-temperature flash. The double-color-temperature flash refers to a combination of a warm-light flash and a cold-light flash, and may be used for light compensation under different color temperatures.

The audio circuit 2407 is configured to provide an audio interface between a user and the computer device 2400. The audio circuit 2407 may include a microphone and a loudspeaker. The microphone is configured to acquire sound waves of a user and an environment, and convert the sound waves into electrical signals and input the electrical signals into the processor 2401 for processing, or input the electrical signals into the radio frequency circuit 2404 to implement speech communication. For the purpose of stereo sound collection or noise reduction, there may be a plurality of microphones, respectively disposed at different parts of the computer device 2400. The microphone may further be an array microphone or an omni-directional acquisition type microphone. The loudspeaker is configured to convert electric signals from the processor 2401 or the radio frequency circuit 2404 into sound waves. The loudspeaker may be a conventional thin-film loudspeaker or a piezoelectric ceramic loudspeaker. When the loudspeaker is the piezoelectric ceramic loudspeaker, the speaker can not only convert an electrical signal into sound waves audible to a human being, but also convert an electrical signal into sound waves inaudible to the human being for ranging and other purposes. In some embodiments, the audio circuit 2407 may also include an earphone jack.

The power supply 2408 is configured to supply power to components in the computer device 2400. The power supply 2408 may be an alternating current, a direct current, a primary battery, or a rechargeable battery. When the power supply 2408 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a quick charge technology.

In some embodiments, the computer device 2400 may further include one or more sensors 2409. The one or more sensors 2409 include, but are not limited to, an acceleration sensor 2410, a gyroscope sensor 2411, a pressure sensor 2412, an optical sensor 2413, and a proximity sensor 2414.

The acceleration sensor 2410 may detect accelerations on three coordinate axes of a coordinate system established by the computer device 2400. For example, the acceleration sensor 2410 may be configured to detect components for gravity acceleration on the three coordinate axes. The processor 2401 may control, according to a gravity acceleration signal collected by the acceleration sensor 2410, the touch display screen 2405 to display on a user interface using a horizontal view or a longitudinal view. The acceleration sensor 2410 may be further configured to acquire motion data of a game or a user.

The gyroscope sensor 2411 may detect a body direction and a rotation angle of the computer device 2400. The gyroscope sensor 2411 may cooperate with the acceleration sensor 2410 to collect a 3D action by the user on the computer device 2400. The processor 2401 may implement the following functions according to the data collected by the gyroscope sensor 2411: motion sensing (such as changing the UI according to a tilt operation of the user), image stabilization during shooting, game control, and inertial navigation.

The pressure sensor 2412 may be disposed on a side frame of the computer device 2400 and/or a lower layer of the touch display screen 2405. When the pressure sensor 2412 is disposed at the side frame of the computer device 2400, a holding signal of the user on the computer device 2400 may be detected, and left/right hand identification and a quick operation may be performed according to the holding signal. When the pressure sensor 2412 is disposed at the lower layer of the touch display screen 2405, an operable control on the UI interface can be controlled according to a pressure operation of the user on the touch display screen 2405. The operable control includes at least one of a button control, a scroll-bar control, an icon control, and a menu control.

The optical sensor 2413 is configured to acquire ambient light intensity. In an embodiment, the processor 2401 may control display brightness of the touch display screen 2405 according to the ambient light intensity collected by the optical sensor 2413. Specifically, when the ambient light intensity is relatively high, the display brightness of the touch display screen 2405 is increased. When the ambient light intensity is relatively low, the display brightness of the touch display screen 2405 is reduced. In another embodiment, the processor 2401 may further dynamically adjust a camera parameter of the camera component 1406 according to the ambient light intensity collected by the optical sensor 2413.

The proximity sensor 2414, also referred to as a distance sensor, is usually disposed on the front surface of the computer device 2400. The proximity sensor 2414 is configured to collect a distance between a front face of a user and a front surface of the computer device 2400. In an embodiment, when the proximity sensor 2414 detects that the distance between the front face of the user and the front face of the computer device 2400 gradually becomes small, the touch display screen 2405 is controlled by the processor 2401 to switch from a screen-on state to a screen-off state. When the proximity sensor 2414 detects that the distance between the user and the front surface of the computer device 2400 gradually becomes large, the touch display screen 2405 is controlled by the processor 2401 to switch from the screen-off state to the screen-on state.

A person skilled in the art may understand that the structure shown in FIG. 24 does not constitute any limitation on the computer device 2400, and the computer device may include more components or fewer components than those shown in the figure, or some components may be combined, or a different component deployment may be used.

An embodiment of this application further provides a computer device, including a processor and a memory. The memory stores at least one computer program, and the at least one computer program is loaded and executed by the processor, to implement the game skill casting method provided in the foregoing method embodiments.

An embodiment of this application further provides a computer-readable storage medium. The computer-readable storage medium has at least one computer program stored therein, and the at least one computer program is loaded and executed by a processor, to implement the game skill casting method provided in the foregoing method embodiments.

Correspondingly, an embodiment of this application further provides a computer program product, including a computer program. The computer program is stored in a computer-readable storage medium. A processor of a computer device reads the computer program from the computer-readable storage medium, and the processor executes the computer program, to enable the computer device to perform the game skill casting method provided in the foregoing method embodiments.

"Plurality of" mentioned in this specification means two or more. "And/or" describes an association relationship for describing associated objects and represents that three relationships may exist. For example, A and/or B may represent the following three cases: Only A exists, both A and B exist, and only B exists. The character "/" generally indicates an "or" relationship between the associated objects.

A person of ordinary skill in the art may understand that all or some of the steps of the method embodiments may be implemented by hardware or a program instructing relevant hardware. The program may be stored in a computer-readable storage medium. The storage medium mentioned above may be a ROM, a magnetic disk, or an optical disc.

In the embodiments of this application, the term "module" or "unit" refers to a computer program having a predetermined function or a part of the computer program, and works together with other relevant parts to achieve a predetermined objective, and may be all or partially implemented by using software, hardware (for example, a processing circuit or a memory), or a combination thereof. Similarly, one processor (or a plurality of processors or memories) may be configured to implement one or more modules or units. In addition, each module or unit may be a part of an overall module or unit including a function of the module or unit.

The foregoing descriptions are merely embodiments of this application, but are not intended to limit this application. Any modification, equivalent replacement, or improvement made within the spirit and principle of this application shall fall within the protection scope of this application.

What is claimed is:

1. A game skill casting method performed by a computer device, the method comprising:
displaying a player character located in a virtual environment;
controlling the player character to cast an initiation skill in response to a first skill casting operation by a user of the computer device;
controlling the player character to cast a flash skill in response to receiving a second skill casting operation by the user of the computer device in a process of casting the initiation skill;
in response to a virtual character existing in the virtual environment in a process of casting the flash skill, determining one of a skill impact location of the initiation skill and a skill impact location of the flash skill as a location of the virtual character; and
applying a correspond one of the initiation skill and the flash skill on the virtual character at the location of the virtual character.

2. The method according to claim 1, wherein the initiation skill is a directional skill; and the determining one of the skill impact location of the initiation skill and the skill impact location of the flash skill as the location of the virtual character comprises:
in response to a casting direction of the initiation skill being a first direction and the virtual character existing in a second direction in the virtual environment in the casting process of the flash skill, determining the skill impact location of the flash skill as the location of the virtual character, wherein the first direction and the second direction are different directions.

3. The method according to claim 1, wherein the initiation skill is a directional movement skill having a default movement length; and
the determining one of the skill impact location of the initiation skill and the skill impact location of the flash skill as the location of the virtual character comprises:
in response to a casting direction of the initiation skill being a first direction and the virtual character existing in a second direction in the virtual environment in the casting process of the flash skill, determining one of a movement impact location of the initiation skill and the skill impact location of the flash skill as the location of the virtual character, wherein
the first direction and the second direction are different directions, and a movement distance corresponding to the movement impact location is different from the default movement length.

4. The method according to claim 1, wherein the determining one of the skill impact location of the initiation skill and the skill impact location of the flash skill as the location of the virtual character comprises:
in response to the virtual character existing in a circular region or a fan-shaped region whose distance to the player character is less than a distance threshold in the virtual environment in the casting process of the flash skill, determining one of the skill impact location of the initiation skill and the skill impact location of the flash skill as the location of the virtual character; or
in response to the virtual character existing in another shaped region determined by using the player character as a center in the virtual environment in the casting process of the flash skill, determining one of the skill impact location of the initiation skill and the skill impact location of the flash skill as the location of the virtual character, wherein
the another shaped region is a shaped region other than the circular region or the fan-shaped region.

5. The method according to claim 1, wherein the virtual character is an enemy virtual character closest to the player character in the virtual environment.

6. The method according to claim 1, wherein the virtual character is an enemy virtual character having a lowest attribute value in the virtual environment.

7. The method according to claim 1, wherein the method further comprises:
searching the virtual environment for the virtual character when the casting operation on the flash skill conforms to an operation manner of quick casting, wherein
the quick casting is an operation manner in which a flash direction and/or a flash impact location of the flash skill are/is not selected.

8. The method according to claim 1, wherein the determining one of the skill impact location of the initiation skill and the skill impact location of the flash skill as the location of the virtual character comprises:
in response to the virtual character existing in the virtual environment in the casting process of the flash skill, determining the skill impact location of the initiation skill as the location of the virtual character, and displaying the skill impact location of the flash skill at a location whose distance to the virtual character is less than or equal to a distance threshold.

9. The method according to claim 1, wherein the determining one of the skill impact location of the initiation skill and the skill impact location of the flash skill as the location of the virtual character comprises:
in response to the virtual character existing in the virtual environment in the casting process of the flash skill, determining the skill impact location of the flash skill as the location of the virtual character.

10. The method according to claim 1, wherein the method further comprises:
displaying at least one of an attribute value, aura information, and a skill indicator from the player character to the virtual character of the virtual character in the virtual environment.

11. The method according to claim 1, wherein the method further comprises:
when the flash skill conforms to an operation manner of active aiming, or the virtual character does not exist in the virtual environment, displaying the skill impact location of the initiation skill as a location indicated by a trigger operation on the flash skill, wherein
the active aiming is an operation manner in which the flash direction and/or the flash impact location of the flash skill are/is selected.

12. The method according to claim 1, wherein the method further comprises:
transmitting a first message to the flash skill in response to the first casting operation on the initiation skill; and
determining, based on the first message, that a response manner of the flash skill is to search for the virtual character in an operation manner of quick casting.

13. The method according to claim 1, wherein the method further comprises:
transmitting a second message to the flash skill in response to an end of casting the initiation skill; and
determining, based on the second message, that a response manner of the flash skill is to use a location within a skill range of the flash skill as a skill impact location in an operation manner of quick casting.

14. A computer device, comprising a processor and a memory, the memory storing a computer program, the computer program, when executed by the processor, causing the computer device to implement a game skill casting method including:
displaying a player character located in a virtual environment;
controlling the player character to cast an initiation skill in response to a first skill casting operation by a user of the computer device;
controlling the player character to cast a flash skill in response to receiving a second skill casting operation by the user of the computer device in a process of casting the initiation skill;
in response to a virtual character existing in the virtual environment in a process of casting the flash skill, determining one of a skill impact location of the initiation skill and a skill impact location of the flash skill as a location of the virtual character; and
applying a correspond one of the initiation skill and the flash skill on the virtual character at the location of the virtual character.

15. The computer device according to claim 14, wherein the initiation skill is a directional skill; and the determining one of the skill impact location of the initiation skill and the skill impact location of the flash skill as the location of the virtual character comprises:
in response to a casting direction of the initiation skill being a first direction and the virtual character existing in a second direction in the virtual environment in the casting process of the flash skill, determining the skill impact location of the flash skill as the location of the virtual character, wherein the first direction and the second direction are different directions.

16. The computer device according to claim 14, wherein the initiation skill is a directional movement skill having a default movement length; and
the determining one of the skill impact location of the initiation skill and the skill impact location of the flash skill as the location of the virtual character comprises:
in response to a casting direction of the initiation skill being a first direction and the virtual character existing in a second direction in the virtual environment in the casting process of the flash skill, determining one of a movement impact location of the initiation skill and the skill impact location of the flash skill as the location of the virtual character, wherein
the first direction and the second direction are different directions, and a movement distance corresponding to the movement impact location is different from the default movement length.

17. The computer device according to claim 14, wherein the determining one of the skill impact location of the initiation skill and the skill impact location of the flash skill as the location of the virtual character comprises:
in response to the virtual character existing in a circular region or a fan-shaped region whose distance to the player character is less than a distance threshold in the virtual environment in the casting process of the flash skill, determining one of the skill impact location of the initiation skill and the skill impact location of the flash skill as the location of the virtual character; or
in response to the virtual character existing in another shaped region determined by using the player character as a center in the virtual environment in the casting process of the flash skill, determining one of the skill impact location of the initiation skill and the skill impact location of the flash skill as the location of the virtual character, wherein
the another shaped region is a shaped region other than the circular region or the fan-shaped region.

18. A non-transitory computer-readable storage medium, having a computer program stored therein, the computer program, when executed by a processor of a computer device, causing the computer device to implement a game skill casting method including:
displaying a player character located in a virtual environment;
controlling the player character to cast an initiation skill in response to a first skill casting operation by a user of the computer device;
controlling the player character to cast a flash skill in response to receiving a second skill casting operation by the user of the computer device in a process of casting the initiation skill;
in response to a virtual character existing in the virtual environment in a process of casting the flash skill, determining one of a skill impact location of the initiation skill and a skill impact location of the flash skill as a location of the virtual character; and
applying a correspond one of the initiation skill and the flash skill on the virtual character at the location of the virtual character.

19. The non-transitory computer-readable storage medium according to claim 18, wherein the initiation skill is a directional skill; and the determining one of the skill impact location of the initiation skill and the skill impact location of the flash skill as the location of the virtual character comprises:
in response to a casting direction of the initiation skill being a first direction and the virtual character existing in a second direction in the virtual environment in the casting process of the flash skill, determining the skill impact location of the flash skill as the location of the virtual character, wherein the first direction and the second direction are different directions.

20. The non-transitory computer-readable storage medium according to claim 18, wherein the initiation skill is a directional movement skill having a default movement length; and
the determining one of the skill impact location of the initiation skill and the skill impact location of the flash skill as the location of the virtual character comprises:
in response to a casting direction of the initiation skill being a first direction and the virtual character existing in a second direction in the virtual environment in the casting process of the flash skill, determining one of a movement impact location of the initiation skill and the skill impact location of the flash skill as the location of the virtual character, wherein
the first direction and the second direction are different directions, and a movement distance corresponding to the movement impact location is different from the default movement length.
